(19) United States
(12) Patent Application Publication
(10) Pub. No.: US 2026/0057699 A1
(43) Pub. Date: Feb. 26, 2026

(54) VIEWER RETENTION THROUGH ADVANCEMENTS IN DUBBING AND LIP SYNCHRONIZATION

(71) Applicant: Netflix, Inc., Los Gatos, CA (US)

(72) Inventors: Bahareh Azarnoush, Los Gatos, CA (US); Yinghong Lan, Los Gatos, CA (US); Shawn Patrick Cochran, Los Angeles, CA (US); Vinod Bakthavachalam, Brooklyn, NY (US)

(21) Appl. No.: 18/811,431

(22) Filed: Aug. 21, 2024

(51) Int. Cl. G06V 40/20; G06V 10/774; G06V 20/40; G06V 40/16; G10L 15/25; G11B 27/34

(52) U.S. Cl. CPC G06V 40/20; G06V 10/774; G06V 20/41; G06V 20/46; G06V 40/171; G10L 15/25; G11B 27/34

(57) ABSTRACT

A computer-implemented method includes identifying, within a media item, one or more phonemes and visemes that correspond to the phonemes. The method further includes accessing contextual data related to the identified phonemes and corresponding visemes, and identifying specified moments in the media item in which alignment between the phonemes and visemes has an importance level that is above a minimum threshold value based on the contextual data. The method also includes providing, to various entities, an indication of the identified moments in which alignment between the visemes and phonemes has an importance level that is above the minimum threshold value. Various other methods, systems, and computer-readable media are also disclosed.

### BACKGROUND

When users are consuming media items, such as films and television shows, synchronization between audio and video is highly important. In many cases, presentation time stamps (PTS) are used in an effort to ensure that the audio and video align with each other. The presentation time stamps run against a program clock reference (PCR) that aligns the audio and video to a common time signal. PTSs tend to work well for aligning original audio with original video. However, when a media item is dubbed into a secondary language, additional issues arise. Dubbed audio, spoken in a secondary language, does not correspond perfectly to the original video. In some cases, dub artists may attempt to design the dubbed dialogue to roughly match the movement of the speaker's mouth in the original language. This process, however, is often inadequate to create an end product that maintains a viewer's interest.

### SUMMARY

As will be described in greater detail below, the present disclosure generally describes systems and methods for training and implementing machine learning (ML) models to identify specific moments in media items in which alignment between visemes and phonemes has an increased importance level. Other embodiments provide dubbing evaluation results for second-language dubs that have been generated for a media item. Still further, other embodiments indicate an amount by which an improvement to lip synchronization will improve viewer retention of a media item.

In one example, a computer-implemented method for identifying specific moments in a media item in which alignment between visemes and phonemes has an increased importance level. The method includes identifying, within a media item, various phonemes and visemes that correspond to the phonemes. The method further includes accessing contextual data related to the identified phonemes and corresponding visemes and identifying specified moments in the media item in which alignment between the phonemes and visemes has an importance level that is above a minimum threshold value based on the contextual data. The method also includes providing, to various entities, an indication of the identified moments in which alignment between the visemes and phonemes has an importance level that is above the minimum threshold value.

In some embodiments, the indication of the identified moments in which alignment between the visemes and phonemes has the increased level of importance is provided to a dub creator for implementation in creating a dub for the media item. In some cases, the identified moments in the media item are flagged to receive additional scrutiny during creation of the dub for the media item beyond a baseline level of scrutiny. In some examples, the contextual data related to the identified phonemes and visemes includes an indication of video shot type for the identified moment.

In some cases, the contextual data related to the identified phonemes and visemes includes an indication of an amount of lighting in the identified moment. In some embodiments, the contextual data related to the identified phonemes and visemes includes an indication of how clearly a character's mouth is visible in the identified moment. In some examples, the contextual data related to the identified phonemes and visemes includes an indication of a character's face size, the frequency of the character's lips flapping, the identity of the character, the genre of the media item, or the context associated with the identified moment.

In some embodiments, the contextual data related to the identified phonemes and visemes includes an indication of a video shot, a video scene, or a dialogue occurring during the identified moment. In some examples, the contextual data related to the identified phonemes and visemes includes an indication of a character's actions during the identified moment. In some cases, the method further includes generating a dub for the media item, where the identified moments in the media item receive additional scrutiny during creation of the dub beyond a baseline level of scrutiny.

In some examples, identifying, within the media item, the phonemes and the visemes that correspond to the phonemes includes determining when an entity's lips flap and when audio sounds corresponding to the lip flaps occur. In some cases, the method further includes training a machine learning model to identify the specified moments in the media item based on historical data related to other media items. In some embodiments, the machine learning model is a multimodal model that analyzes audio information and video information related to the media item.

In some cases, the above-described method further includes generating a dub for the media item, where additional scrutiny is given to the specified moments in the media item when creating the dub beyond a baseline level of scrutiny. In some embodiments, the method further generates a dubbing evaluation result that indicates how well the dubbed phonemes match the corresponding visemes of the media item. In some examples, the method further initiates a redub of the media item upon determining that the dubbing evaluation result for the media item is below an established threshold value. In some cases, generating the dubbing evaluation result and initiating the redub of the media item forms a feedback loop that provides higher quality dubs. In some examples, the media item includes an animated film or a video game.

A corresponding system includes at least one physical processor and physical memory comprising computer-executable instructions that, when executed by the physical processor, cause the physical processor to: identify, within a media item, various phonemes and visemes that correspond to the phonemes, access contextual data related to the identified phonemes and corresponding visemes, identify specified moments in the media item in which alignment between the phonemes and visemes has an importance level that is above a minimum threshold value based on the contextual data, provide, to one or more entities, an indication of the identified moments in which alignment between the visemes and phonemes has an importance level that is above the minimum threshold value.

In some examples, a corresponding non-transitory computer-readable medium is provided that includes one or more computer-executable instructions that, when executed by at least one processor of a computing device, cause the computing device to: identify, within a media item, various phonemes and visemes that correspond to the phonemes, access contextual data related to the identified phonemes and corresponding visemes, identify specified moments in the media item in which alignment between the phonemes and visemes has an importance level that is above a minimum threshold value based on the contextual data, provide, to one or more entities, an indication of the identified moments in which alignment between the visemes and phonemes has an importance level that is above the minimum threshold value.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example computer architecture in which the embodiments described herein may operate.

FIG. 2 illustrates a flow diagram of an exemplary method for training and implementing machine learning models to identify specific moments in a media item in which alignment between visemes and phonemes has an increased importance level.

FIG. 3 illustrates an alternative example computer architecture in which the embodiments described herein may operate.

FIG. 4 illustrates an alternative example computer architecture in which the embodiments described herein may operate.

FIG. 5 illustrates an embodiment of a computing environment in which lip flap quality may be improved.

FIG. 6 illustrates an embodiment of a computing environment in which a dub is created, evaluated, and updated in a feedback loop.

FIG. 7 illustrates an example computer architecture in which the embodiments described herein may operate.

FIG. 8 illustrates a flow diagram of an exemplary method for providing dubbing evaluation results for dubs that have been generated for a media item.

FIG. 9 illustrates an embodiment of a computing environment in which lip shape quality may be improved through phoneme viseme matching.

FIG. 10 illustrates an alternative embodiment of a computing environment in which lip shape quality may be improved through phoneme transcription.

FIGS. 11A and 11B illustrate embodiments in which lip shape quality may be improved through phoneme viseme alignment.

FIG. 12 illustrates an example computer architecture in which the embodiments described herein may operate.

FIG. 13 illustrates a flow diagram of an exemplary method for indicating by how much an improvement to lip synchronization will improve viewer retention of the media item.

FIG. 14 illustrates an embodiment in which scalable metrics for assessing dub quality are presented.

FIG. 15 illustrates an embodiment in which a retention metric is calculated, along with associated factors.

FIG. 16 illustrates an embodiment in which quality drivers are improved for a given media item.

FIG. 17 illustrates an embodiment in which dub quality is improved for a given media item.

FIG. 18 illustrates an embodiment in which dubs are validated and improved in a feedback loop.

FIG. 19 is a block diagram of an exemplary content distribution ecosystem.

FIG. 20 is a block diagram of an exemplary distribution infrastructure within the content distribution ecosystem shown in FIG. 19.

FIG. 21 is a block diagram of an exemplary content player within the content distribution ecosystem shown in FIG. 20.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to systems and methods for training and implementing machine learning (ML) models to identify specific moments in a media item in which alignment between visemes and phonemes has an increased importance level. Other embodiments provide lip synchronization quality evaluations for dubs that have been generated for a given media item. Still further, other embodiments indicate an amount by which an improvement to lip synchronization will improve viewer retention of the media item.

As noted above, whether viewers are watching internet videos, feature-length movies, or television shows, it is highly important for the sound and the video to be synchronized. If the sound is playing ahead of or behind the video, viewers will quickly realize the disconnect and will often stop viewing the media item. Keeping the audio and video in sync allows viewers to be fully immersed in the story presented in the underlying media item. In order to keep audio and video in sync, presentation time stamps (PTS) have been used to ensure that the audio and video align with each other. Presentation time stamps are designed to run against a program clock reference (PCR) that keeps the audio and video aligned to a common time signal. As long as the common time signal is followed, the audio and video will remain in sync.

Other synchronization efforts have been made in the field of dubbing. In current media streaming services, popular movies and television shows are often dubbed into different languages to allow many different cultures second-language speakers to experience these media items. When creating dubbed audio that has been translated and is being spoken in a secondary language (i.e., any non-original language), dub artists may attempt to design the dubbed dialogue to roughly match the movement of the speaker's mouth in the original language. When actors or actresses speak in a movie (or tv show or other media item), they create phonemes. “Phonemes” are distinct sounds made by a person's voice, lips, tongue, mouth, or a combination thereof. Combinations of phonemes form words and sentences. A “viseme” results when a person's mouth moves to create a phoneme. The movement of the person's lips, tongue, or mouth provide an indication that a phoneme was uttered by the actor or actress. Some visemes may correlate to multiple different phonemes. For example, “p,” “b,” and “m” may all share the same viseme, while each corresponding to different phonemes.

With regard to dubbing, although the dubbed audio that is spoken in the secondary language does not correspond perfectly to the original video, dub artists often attempt to design the dubbed dialogue to roughly match the visemes or movements of the speaker's mouth in the original language. These efforts, however, are often applied equally to the entire movie or television show. In at least some cases, as will be described further below, it may be advantageous to focus the dubbing efforts on certain, specific parts of the movie or tv show. For instance, in scenes where the speaker's face is brightly lit, in scenes where the speaker's face is more prominent in the scene, or in scenes where a main character is speaking, it may be advantageous to spend additional time on those scenes to ensure that the scene's dubbed phonemes closely match the scene's existing (original) visemes.

Moreover, at least in some cases, after these dubs have been created, it may be advantageous to continually improve the second-language dubs in their associated media items. In some embodiments, the quality of the second-language dubs may have a strong impact on viewer retention for a media item. For example, a media item with a low-quality dub may fare worse at retaining viewers (e.g., keeping a viewer's interest for a given proportion of the media item, keeping a viewer's interest for at least a minimum number of minutes, keeping the viewer's attention for successive episodes of episodic content, etc.) than other media items that have higher quality dubs. Moreover, media items that have high-quality dubs at specific, high-interest moments within the media item may perform even better at retaining viewership.

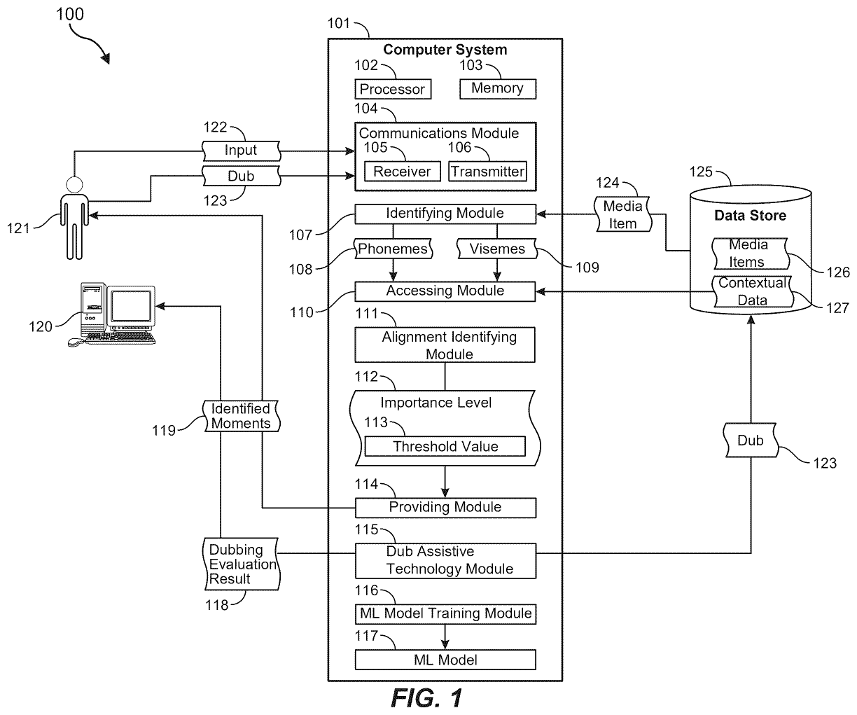

Thus, at least some of the systems described herein may be designed to evaluate and/or score second-language dubs that were created for media items and provide those scores to dub artists and/or as part of assistive technology to the dub creation process. These evaluations and scores may then be used in a feedback loop to improve the quality of the dub. The evaluations may provide specific indications of which scenes may be redubbed in order to improve the quality of the dub and, as a result, improve viewer experience of the media item. Each of these concepts will be described in greater detail below with reference to FIGS. 1-21.

FIG. 1, for example, illustrates a computing environment 100 in which systems and methods for training and implementing machine learning (ML) models to identify specific, key moments in a media item in which alignment between visemes and phonemes has an increased level of importance. FIG. 1 includes various electronic components and elements including a computer system 101 that is used, alone or in combination with other computer systems, to perform associated tasks. The computer system 101 may be substantially any type of computer system including a local computer system or a distributed (e.g., cloud) computer system. The computer system 101 includes at least one processor 102 and at least some system memory 103. The computer system 101 includes program modules for performing a variety of different functions. The program modules may be hardware-based, software-based, or may include a combination of hardware and software. Each program module uses computing hardware and/or software to perform specified functions, including those described herein below.

In some cases, the communications module 104 is configured to communicate with other computer systems. The communications module 104 includes substantially any wired or wireless communication means that can receive and/or transmit data to or from other computer systems. These communication means include, for example, hardware radios such as a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 is configured to interact with databases, mobile computing devices (such as mobile phones or tablets), embedded computing systems, or other types of computing systems.

The computer system 101 further includes an identifying module 107. The identifying module 107 is configured to identify phonemes 108 and visemes 109 within a media item 124. The media item 124 may be one of many different media items 126 stored in a data store 125. The data store 125 may be local or remote to computer system 101 and, in some cases, may be a distributed or cloud-based data storage system. The media item 124 may be a movie, a television show, an internet video, an audio file such as a song or podcast, a video game, or other type of containerized or streaming media item. Although many of the embodiments described herein will reference movies, it will be understood that these embodiments could equally apply to any type of media item.

In at least some embodiments, the media item 124 includes one or more speakers (e.g., actors or actresses or amateur video creators) speaking various lines of dialogue. Each spoken sound corresponds to a phoneme 108, and each viseme 109 corresponds to at least one phoneme (and, in some cases, multiple phonemes). The identifying module 107 may be configured to identify speaking persons in the media item 124 by analyzing face movement, including movement of the mouth, lips, tongue, cheeks, or other features that indicate that a person (or animated non-human character) is speaking.

In some cases, the identifying module 107 uses a machine learning model 117 generated by the ML model training module 116 to identify the phonemes 108 and/or visemes 109. The ML model 117 may be configured to analyze many different movies and television shows and, for each media item, identify moments or scenes that include speaking persons. The ML model may then analyze mouth movement or other features to determine which visemes 109 are being formed by the speaking person. The ML model 117 may also analyze original audio data for those scenes to identify which phonemes 108 are being made by the speaking person.

Additionally or alternatively, the accessing module 110 of computer system 101 may access contextual data 127 stored in the data store 125. The contextual data 127 includes data relating to the media item 124, including (but not limited to) an identification of the actors or actresses in the movie, an indication of the length of the movie, an indication of the original language of the movie, an indication of the genre of the movie, an indication of scene start and stop times, or other data related to the movie. The accessing module 110 may access this contextual data 127 and correlate the contextual data to the phonemes 108 and visemes 109 identified by the identifying module 107. The contextual data 127 may help contextualize the phonemes 108 and visemes 109, adding information about the visemes that may be used by the alignment identifying module 111 to determine the importance of aligning those specific phonemes with those specific visemes, potentially for each scene or key moment.

Indeed, the alignment identifying module 111 may be configured to identify moments in the media item 124 in which the importance level 112 of aligning the phonemes 108 and visemes 109 is above a minimum threshold value 113, based on the contextual data 127. Thus, for example, a baseline importance level may be assigned to a given media item. That threshold value 113 may be different for different movies or television shows. For instance, more popular titles may be assigned a higher minimum threshold value 113, while other media items will be assigned a lower minimum threshold value of importance. Still further, within a media item, different scenes, different characters, or different moments may receive a higher minimum threshold value 113. This minimum threshold value 113 may be established based on a variety of different criteria, as will be explained further below.

Once the alignment identifying module 111 has identified specific moments 119 in which alignment between the visemes 109 and phonemes 108 has an importance level 112 that is above the minimum threshold value 113, the providing module 114 may be configured to provide an indication of the identified moments 119 to one or more specific entities (e.g., dub artist or other user 121 and/or computer system 120). The dub artist may, for example, use the indication of identified moments 119 to focus on those key moments when creating a dub 123. The dub artist may, for instance, spend more time creating translated dialogue whose phonemes match the existing visemes for scenes that feature close-up, well-lit views of a main actor's face. That movie, when dubbed, will then benefit from the extra scrutiny given by the dub artist to that scene. This overall process will be described in greater detail with respect to method 200 of FIG. 2 and FIGS. 1-6 below.

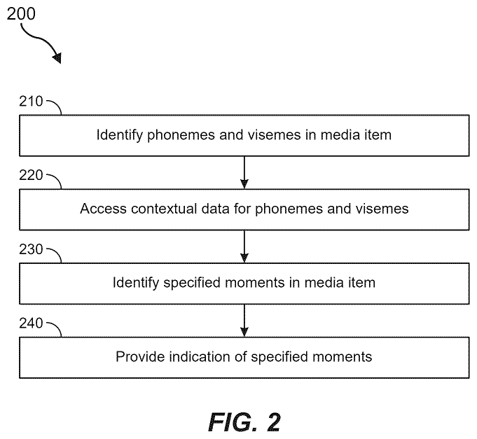

FIG. 2 is a flow diagram of an exemplary computer-implemented method 200 for training and implementing machine learning (ML) models to identify specific moments in a media item in which alignment between visemes and phonemes has an increased importance level. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below.

Method 200 includes, at 210, a step for identifying, within a media item (e.g., 124), one or more phonemes 108 and one or more visemes 109 that correspond to the phonemes. At step 220, method 200 includes accessing one or more portions of contextual data 127 related to the identified phonemes 108 and corresponding visemes 109, and at step 230, method 200 includes identifying one or more specified moments 119 in the media item 124 in which alignment between the phonemes 108 and visemes 109 has an importance level 112 that is above a minimum threshold value 113 based on the contextual data 127. Furthermore, method 200 includes, at step 240, providing, to one or more entities (e.g., 120 or 121), an indication of the identified moments 119 in which alignment between the visemes 109 and phonemes 108 has an importance level 112 that is above the minimum threshold value 113.

The computer system 101 of FIG. 1 may thus be implemented to analyze media items and identify, within those media items, specific moments 119 that are to receive additional scrutiny. Those moments may be flagged to receive additional scrutiny during creation of a dub for the media item. The flagging may include metadata, for example, that indicates time stamps of when the various identified moments begin and end within the media item. Identified moment #1, for instance, may occur between 1:31-2:05, identified moment #2 may occur between 10:27-10:57, identified moment #3 may occur between 33:16-35:21, and so on. The dub artist or dub creating entity may acknowledge these identified moments 119 and spend additional time creating the dubs that occur during those moments.

Thus, for instance, when a human is creating a dub 123 for the media item either fully manually or leveraging assistive technology such as machine translation, the entity creating the dub (i.e., the “dub creator”) may be informed by the identified moments 119 that they are to expend additional time, energy, and thought or computation to creating the dub 123 for those moments. If, for example, the dub creating entity applied a baseline level of scrutiny to creating the dub for the media item, that entity would apply a defined amount of time and resources to generating an appropriate translation and to creating a dub in which phonemes in the dubbed, secondary language at least partially matched the original visemes of the media item 124. The embodiments herein may be configured to identify moments in a media item where alignment between phonemes and visemes is of higher importance. These moments may then be given additional scrutiny when generating the dub 123 to ensure that phoneme/viseme alignment is even tighter than it is in other scenes or moments. The contextual data 127 may provide indications of when those moments may occur in the media item.

In some cases, for instance, the contextual data related to the identified phonemes 108 and visemes 109 includes an indication of video shot type for a given identified moment 119 in the media item. The video shot type may indicate that the shot is a zoomed-in, close-up shot in which the speaker's mouth is more clearly visible. In such cases, it may be more important to have phoneme/viseme alignment than it is when speaking characters are further away from the camera and whose mouth movements are less visible. Video shot type may also indicate whether the shot is a dialogue scene, or a romantic scene, or an action scene, or an environment scene, or other type of video shot. Each video shot type may indicate a higher or lower level of importance when creating the dub 123.

In some embodiments, the contextual data 127 related to the identified phonemes 108 and visemes 109 includes an indication of an amount of lighting in the identified moment. If a video scene or shot is well lit and has a large amount of light, the speaker's features, and particularly the movements of their mouth, will be more readily visible. If a video scene or shot is poorly lit and has a small amount of light, the speaker's mouth movements will be less visible or may be indeterminable. In some cases, the dub artist or ML model may establish a baseline amount of light that is to be in a video scene for it to be identified as a moment of high importance. If the amount of light or brightness in the scene is above the baseline amount or above an established threshold, that scene may be recommended as one with an importance level 112 that is beyond a threshold value 113. That scene may then be identified as a key moment for which phoneme/viseme alignment is to be emphasized.

Still further, in some cases, the contextual data 127 related to the identified phonemes 108 and visemes 109 include an indication of how clearly a character's mouth is visible in the identified moment 119. In some embodiments, the ML model 117 may be trained to identify mouth movement, including lip movement, tongue movement, cheek movement, or other facial movement that indicates speech. The ML model 117 may analyze thousands or millions of media items (or more) and learn to identify when characters are speaking. The ML model 117 may be further refined to identify a baseline measurement indicating how clearly a character's mouth is visible. If the mouth visibility is above the baseline measurement or is above an established threshold amount, the ML model 117 may recommend that the scene be assigned a high importance level 112 and that the scene be identified as a key moment that is to receive additional scrutiny.

Continuing these examples, the contextual data related to the identified phonemes 108 and visemes 109 may include any of the following: an indication of a character's face size, a frequency of the character's lips flapping, an identity of the character, a genre of the media item, a context associated with the identified moment, an indication of a video shot, a video scene, or a dialogue occurring during the identified moment, or an indication of a character's actions during the identified moment.

Thus, the dub artist (e.g., 121) or ML model 117 may be configured to look at the size of the character's face in the scene (e.g., larger sizes would indicate a higher importance level), the frequency of the speaking character's lips flapping (e.g., higher frequency would indicate a higher importance level), the identity of the speaking character (e.g., identification as a main character who frequently appears throughout the media item or identification as a known actor or actress would indicate a higher importance level), the genre of the media item (e.g., romance or comedies would indicate a higher importance level, while action scenes would indicate a lower importance level), the context of the identified moment 119 (e.g., monologue or conversation between two people would indicate a higher importance level, or specific words in the dialogue would indicate a higher importance level), or the character's actions during the identified moment (e.g., one character is intently listening to another character speak would indicate a higher importance level). The above are merely examples of contextual data 127 and how that contextual information could be used to determine whether a given scene, shot, or other moment will receive an importance value 112 that is beyond the threshold value 113.

The dub artist (e.g., 121) may leverage the dub assistive technology module 115 of computer system 101 or ML model 117 to generate a dub 123 for the media item. The dub 123 may include audio spoken in a secondary language that is different from the original language of the media item 124. During generation of the dub 123, the identified moments 119 in the media item receive additional scrutiny during creation that goes beyond a baseline level of scrutiny. As noted above, this heightened level of scrutiny may lead to additional time spent during translation identifying words whose phonemes 108 will match the established visemes 109 of the scene. Additional time may also be spent speaking the words of the dub and pronouncing the words in the proper way and in a manner and timing that better aligns with the established visemes. Still further, additional time may be spent altering the timing of the spoken words in the dub, either condensing the words so that the words are closer together, or spreading out the words so that the words are temporally further apart in order to align with the visemes. Thus, increased scrutiny may allow for multiple different optimizations that, either alone or together, increase the quality of the dub 123.

In some cases, after generating the dub 123, in which additional time and attention are given to the specified moments 119 in the media item 124, the computer system 101 (e.g., the dub assistive tech module 115) may generate a dubbing evaluation result 118 that indicates how well the dubbed phonemes 108 match the corresponding visemes 109 of the media item. The dubbing evaluation result 118 may analyze the entire media item 124 or may analyze only the specified moments 119 for the media item. This analysis may look at each instance in which a phoneme is formed by a speaking user and determine how well that phoneme matches the corresponding viseme that is being presented at that moment. The correspondence between phonemes and visemes, including temporal and visual alignment with lip flap or lip movement, may indicate, for the entire media item or for the specified moments 119, how well the phonemes and visemes align and, thus, the overall quality of the dub. The dubbing evaluation result 118 may provide a dub quality score for the entire media item 124 and may also provide a breakdown of sub-scores indicating the dub quality of each specified moment 119 in the media item.

In some embodiments, if the dubbing evaluation result 118 for the media item 124 is below an established threshold value, the computer system 101 may initiate a redub of the media item. The redub may focus on portions of the dub that were below the dub quality threshold level (i.e., portions of the dub where alignment between the phonemes and visemes was unacceptably low). This newly created redub may then be analyzed by the computer system in the same manner as the original dub. The dubbing evaluation result 118 for the redub may similarly be analyzed to determine whether the redub meets the dub quality threshold value. If not, the computer system 101 may initiate another redub. If so, the redub may be accepted and may be associated with the media item 124. This process, then, of generating a dubbing evaluation result 118 and initiating a redub of the media item, forms a feedback loop. The feedback loop keeps refining the dub or keeps helping generate new dubs that result in higher quality dubs.

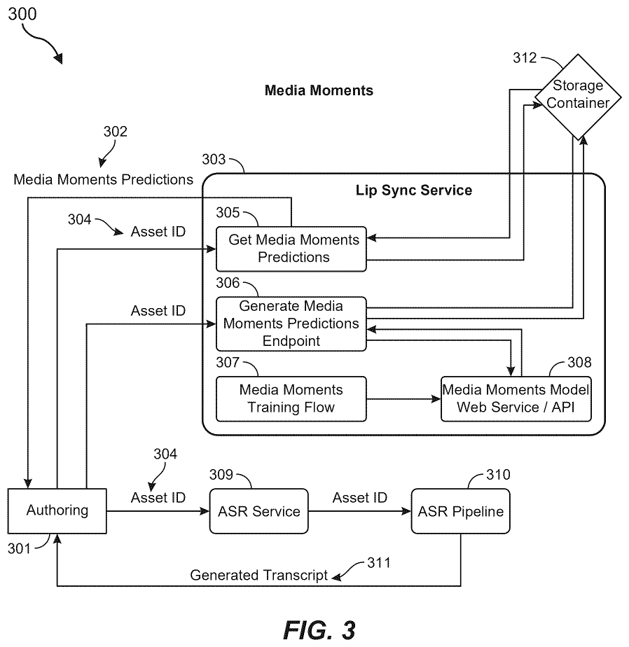

FIG. 3 illustrates an embodiment of a computing architecture 300 for identifying media moments and for generating dubs for media items. These “media moments” may refer to those portions of a media item that are to receive extra attention when the corresponding dub is created. The media moments are scenes, shots, or simply time codes indicating portions of the media item for which alignment between phonemes and visemes is of increased importance. Scenes or shots that are well lit, prominently feature a single speaker or a pair of speakers, clearly show movement of the speakers' mouths, or otherwise clearly show a person speaking may be flagged to receive additional scrutiny when generating the dub. Identifying these media moments increases the overall quality of the dub and the overall quality of the viewing user's experience. Flagging the media moments can assist with the creation of dubs.

The computer architecture 300 of FIG. 3 includes an authoring tool 301 that is configured to create dubs for media items. The authoring tool 301 may access a media item (referred to here as an “Asset” or “Asset ID”). The asset ID 304 may be sent to an automatic speech recognition (ASR) service 309. The ASR service 309 may initiate a speech recognition process that analyzes the media item to determine which words are being spoken. The ASR pipeline 310 analyzes lip movement, along with phonemes to recognize words. The ASR pipeline 310 then generates a transcript 311 of the identified words. The transcript may cover the entire media item or just the identified media moments.

The media moments model web service or application programming interface (API) 308 may then be implemented to analyze the media item in light of other media items that were previously processed. The media moments training flow 307 may indicate historical training data gleaned from analyzing many other media items, identifying the media moments in those media items, and determining a dubbing evaluation result or dubbing score for those media moments. This dubbing score may then be used as feedback to refine the web service/API 308. As such, the web service/API 308 (or the ML model accessed through the web service/API) may improve over time and may lead to dubs of higher quality, in which the phonemes of the dub align more closely to the visemes of the original media item.

In some embodiments, the media moments model of FIG. 3 may thus be implemented to predict the most important moments to have high quality lip sync, based at least partially on historical data. In some cases, the authoring tool 301 receives a request for a pivot language dialogue list (PLDL) (e.g., where a dialogue list includes the spoken language in a media item transcribed from its original source language, and where a PLDL includes spoken language fully transcribed in its original language, translated into a pivot (secondary) language). The authoring tool then generates a PLDL for a specific asset, which is identified by asset ID 304. The asset ID 304 is then forwarded from the authoring tool 301 to both the ASR service 309 and the media moments model web service/API 308. The ASR service 309 sends back a transcription file with an initial transcription.

The asset ID 304 is then sent to the media moments predictions endpoint 306 within the lip sync service 303. Upon being sent to this endpoint, the lip sync service 303 initiates a workflow. This workflow is configured to download the asset identified by the asset ID 304, run the asset through the lip sync pipeline (e.g., starting at 305), generate embeddings for the asset, and collect the other metadata needed for prediction. At the final step of this workflow, the lip sync service 303 then has all of the data required to make a media moment prediction. In some cases, these features can be fed to an ML model to generate a prediction.

In some embodiments, the lip sync service 303 includes a workflow that continuously (e.g., daily) trains the underlying media moments model (e.g., at 307) and pushes the latest model to a web service 308. This web service expects an incoming payload of some or all the features needed to make a prediction of key moments for a given title and returns the predictions. Raw predictions 302 are calculated (e.g., at a specified number per second) identifying specific moments in the media item. This group of key moments is then reduced to a certain number (e.g., 10) of final key moments by identifying those candidates in the media item.

In some cases, more moments are identified in the first portion (e.g., in the first 15 minutes) of the media item. The list of candidates is then further narrowed to (e.g., five) moments, each using a combination of the prediction key moment score and other contextual data (e.g., the prominence of faces in the scene). The end result, in this example, is five key moments in the first 15 minutes and five key moments in the remainder of the title. In this case, if a title is under 15 minutes, the system will only surface five key moments. The key moments may be stored in storage container 312. Once the PLDL has been marked as ready, the get media moments predictions endpoint 306 can be queried to retrieve the identified media moments.

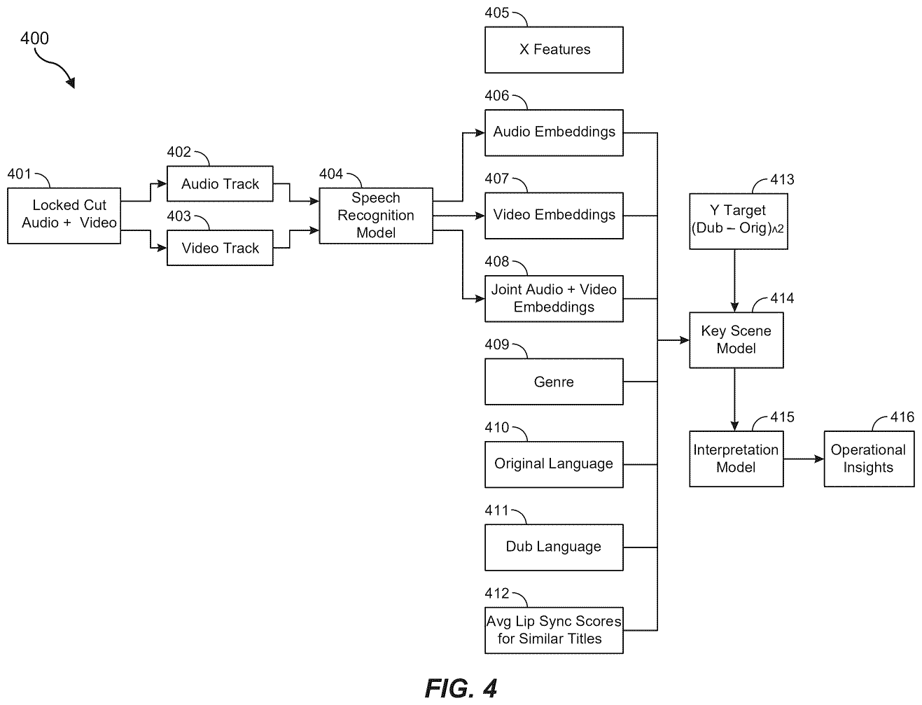

FIG. 4 illustrates an alternative computing architecture 400 for identifying key moments in media items during which alignment between phonemes and visemes is of increased importance. The computing architecture 400 includes various software and/or hardware modules that allow optimization and independence between various parts of the workflow. At least in some cases, the workflow begins with a locked cut 401 with separate video and audio tracks. The locked cut 401 may be a finalized version of the media item with finalized video for which the audio may be matched in a dub. The audio track 402 and the video track 403 are fed into a speech recognition model 404 to process the multimodal input data (e.g., both audio and video). The speech recognition model 404 may output audio embeddings 406, video embeddings 407, and joint audio and video embeddings 408 as X features 405 for the key scenes model 414. At least in some cases, these X features 405 are used to predict speech recognition scores on the original locked cut video.

In some embodiments, these X features 405 may be combined with contextual metadata such as genre 409, original language 410, dub language 411, and derived features such as the average lip sync score 412 of similar titles (e.g., titles that match on similar embeddings, dub language, and potentially original language). Thus, in this manner, the audio embeddings 406, the video embeddings 407, the joint embeddings 408, the genre 409, the original language 410, the dub language 411, the average lip sync scores 412, and other data may be combined to form the set of X features. The X features may then be used to predict speech recognition scores for the original video. At least in some embodiments, the key scenes model 414 may implement a target defined as the squared difference between the second-language dub and the original language scores (413), which represents a measure of lip sync quality. Under this definition, the scores are positive and larger numbers imply worse lip sync quality.

Predictions are then made at the second level. This aggregation from frame to second rolls up the predictions to a reasonable level that enables the underlying system to join original and dub language speech recognition scores together as well as match the frequency of dialogue lines to help alignment with PLDL files. For the key scenes model 414, the system may compare the performance of various algorithms. To establish an initial baseline, the system may use specific models, or may use neural networks and other modeling approaches. The system may then feed the predicted scores into an interpretation model 415. This transforms the continuous predictions into an output that may be useful for flagging areas where lip sync quality is of higher importance.

In some cases, the system can overlay the predicted lip sync quality scores with where the key moments take place in the media item. This may allow the system to upweight or increase the score of earlier scenes, since those scenes will likely be seen by more viewers and will likely be more impactful on viewer retention. The system may also translate the continuous prediction into high-level labels (e.g., operational insights 416) that may be more interpretable, such as high risk, medium risk, or low risk. Such operational insights may be implemented to focus resources on particularly scenes that need additional attention.

At least in some cases, the models of FIG. 4 may be or may incorporate supervised models that seek to predict lip sync quality of a particular dub title using contextual information that is available potentially before the title is offered for streaming on a media streaming service. At least one target of these models is the expected speech recognition scores and/or lip sync scores for a given dub. At least in some cases, lip sync scores may be measured per speaker in a title and on a frame-by-frame basis. The embodiments herein may attempt to align the time codes and/or sequence of predicted lip sync scores with time codes in PLDL files in order to aid in key moment identification.

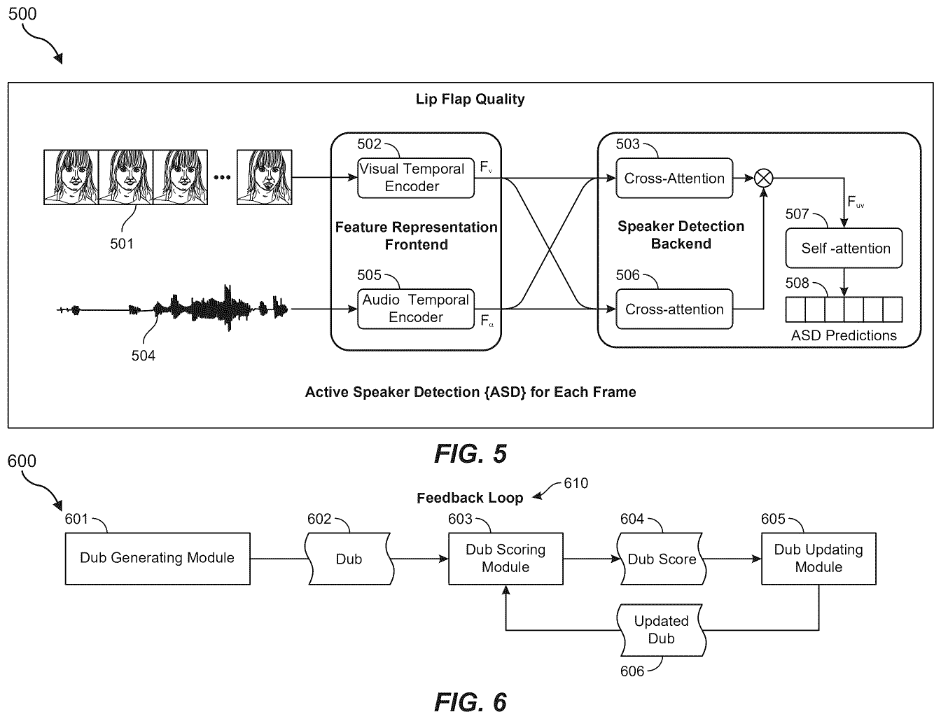

FIG. 5 illustrates an embodiment in which lip flap quality may be analyzed when a person is speaking. Lip flaps occur when a speaking person creates sounds with their lips. As the lips flap in certain patterns, the speaking user forms different phonemes. Thus, as noted above, the process of identifying, within the media item, the various phonemes and the visemes that correspond to the phonemes may include determining when a speaking person's lips flap and when audio sounds corresponding to the lip flaps occur. The system's ability to identify when and how the speaking person's lips are flapping may greatly increase the overall quality of the lip synchronization in the media item's dub. Within the computing environment 500 of FIG. 5 a machine learning model may be trained to analyze a speaking user's lip movements. The speaking user 501 may speak in a variety of video frames in a media item.

The system takes as inputs, not only the visemes of the speaking person 501, but also the corresponding audio 504 created by the speaking person. The visemes are processed by a visual temporal encoder 502, while the phonemes are processed by an audio temporal encoder 505. The outputs of the visual temporal encoder 502 and the audio temporal encoder 505 are fed to a speaker detection backend having a visual cross-attention module 503 and an audio cross-attention module 506 that are configured to determine, for each video frame, who the active speaker is and, in some cases, determine an indication of lip sync quality for the frame. The lip sync quality may include not only phoneme/viseme alignment, but may also take into consideration other factors including, but not limited to, voice acting quality, voice actor match, dialogue clarity, overall audio clarity, dialogue naturalness, dialogue audio quality, translation match, and other factors. The self-attention module 507 may generate indications of active speaker predictions 508 in each frame (or for at least some frames) and/or may provide lip sync score predictions for the entire media item or for specified moments within the media item.

FIG. 6 illustrates an embodiment of a computing architecture 600 with various hardware and/or software modules configured to provide a feedback loop 610 for improving dubs in media items. At least in some embodiments, the computer architecture 600 includes a dub generating module 601. The dub generating module 601 may be configured to generate second-language or tertiary-language dubs 602 for media items. Once created, the dubs 602 may be scored by the dub scoring module 603. The dub scoring module 603 may be configured to analyze multiple different dubs and their corresponding media items. The dub scoring module 603 may be configured to identify alignments and misalignments between phonemes and visemes within the various media items. Dubs that have higher alignment overall (or higher alignment during key moments) may receive higher dub scores 604. Whereas, dubs that have lower alignment between phonemes and visemes may receive lower dub scores 604.

If the dub scores are lower than a minimum threshold score or value, the dub updating module 605 may be configured to make changes to the dub during specific moments of the media item or may redub the entire media item. In cases where the redub is a partial redub, those moments that had misalignments that were beyond a baseline amount (e.g., 1 ms, 5 ms, 10 ms, 50 ms, 100 ms, etc.), those scenes or shots may be redubbed while leaving the remaining portions of the dub untouched. The updated dub 606 may then be fed to the dub scoring module 603 for a re-scoring. If the updated dub 606 scores above the baseline amount of alignment, the updated dub may be associated with the media item and may be published for public consumption.

At least in some embodiments a machine learning model may be implemented to predict or identify media moments in the media item. Moreover, the machine learning model may be implemented to determine a level of dub quality by analyzing historic data related to dubs created for past media items. The machine learning model may be fed, as inputs, a plurality of different media items and their corresponding dubs. The machine learning model may be trained to analyze audio data and visual data (e.g., lip flap or lip movement data) and determine how well phonemes matched with visemes in the dubbed version. Media items with high levels of alignment between phonemes and visemes, especially at key moments, are identified as positive examples which are to be emulated in future dubs.

At least in some cases, the machine learning model is a multimodal model configured to look at audio data, video data, textual data (e.g., movie transcripts), or other data when predicting key moments or determining dub quality. The multimodal machine learning model may be configured to analyze not only live action videos and movies with real humans being portrayed, but also animated films, video games, or other simulated videos in which one animated person is speaking to another and for which a dub can be created.

In addition to the above-described method, a system may be provided that includes at least one physical processor and physical memory comprising computer-executable instructions that, when executed by the physical processor, cause the physical processor to: identify, within a media item, one or more phonemes and one or more visemes that correspond to the phonemes, access one or more portions of contextual data related to the identified phonemes and corresponding visemes, identify one or more specified moments in the media item in which alignment between the phonemes and visemes has an importance level that is above a minimum threshold value based on the contextual data, and provide, to one or more entities, an indication of the identified moments in which alignment between the visemes and phonemes has an importance level that is above the minimum threshold value.

Still further, a corresponding non-transitory computer-readable medium may be provided that includes one or more computer-executable instructions that, when executed by at least one processor of a computing device, cause the computing device to: identify, within a media item, one or more phonemes and one or more visemes that correspond to the phonemes, access one or more portions of contextual data related to the identified phonemes and corresponding visemes, identify one or more specified moments in the media item in which alignment between the phonemes and visemes has an importance level that is above a minimum threshold value based on the contextual data, and provide, to one or more entities, an indication of the identified moments in which alignment between the visemes and phonemes has an importance level that is above the minimum threshold value.

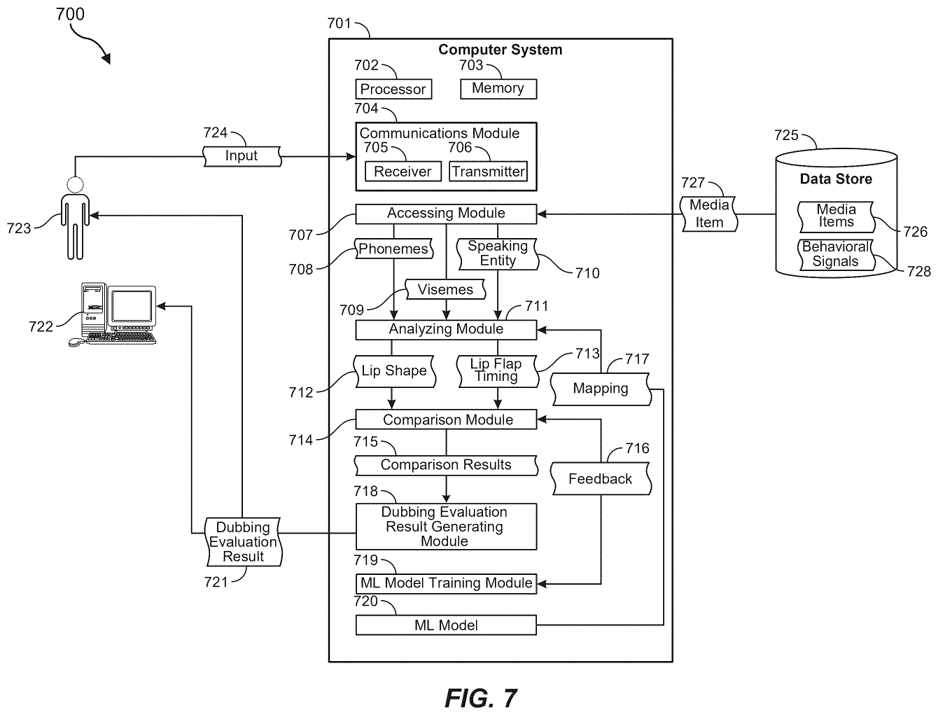

Turning now to FIG. 7, a computing environment 700 is illustrated in which dubbing evaluation results or dubbing scores may be provided for dubs that have been generated for a media item. FIG. 7 includes various electronic components and elements including a computer system 701 that is used, alone or in combination with other computer systems, to perform associated tasks. The computer system 701 may be substantially any type of computer system including a local computer system or a distributed (e.g., cloud) computer system. The computer system 701 includes at least one processor 702 and at least some system memory 703. The computer system 701 includes program modules for performing a variety of different functions. The program modules may be hardware-based, software-based, or may include a combination of hardware and software. Each program module uses computing hardware and/or software to perform specified functions, including those described herein below.

In some cases, the communications module 704 is configured to communicate with other computer systems. The communications module 704 includes substantially any wired or wireless communication means that can receive and/or transmit data to or from other computer systems. These communication means include, for example, hardware radios such as a hardware-based receiver 705, a hardware-based transmitter 706, or a combined hardware-based transceiver capable of both receiving and transmitting data. The radios may be WIFI radios, cellular radios, Bluetooth radios, global positioning system (GPS) radios, or other types of radios. The communications module 704 is configured to interact with databases, mobile computing devices (such as mobile phones or tablets), embedded computing systems, or other types of computing systems.

The computer system 701 further includes an accessing module 707. The accessing module 707 may be configured to access media items 726 from a data store 725. The data store 725 may be any type of local or remote (e.g., cloud-based) data store that is capable of storing and distributing media items. At least in some cases, the accessing module 707 may be configured to access media items 726 that have been dubbed into a secondary language. Thus, for instance, a movie may have originally been filmed in the English language and is then dubbed into Spanish, Japanese, French, Norwegian, or some other secondary language. Or, a television show may have originally been filmed in the Korean language and is then dubbed into English, German, Chinese, Thai, or some other secondary language. Each language has different phonemes associated with it, affecting how that language's words are pronounced. Speakers of those languages form their lips, tongues, throats, or, more generally, their mouths in different ways to produce the sounds of words in that language (i.e., phonemes). These phonemes, then, have corresponding visemes, which indicate how a user's face or mouth appear when forming those phonemes.

As noted above, in a second-language dub for a media item, it may be off-putting for viewers to see a large mismatch or misalignment between phonemes and visemes. As such, the systems herein attempt to create a higher degree of alignment between a speaking person's visemes and the phonemes of the second-language dub. Thus, as part of this process, the accessing module 707 may access a media item 727 that, at least in some cases, has previously been analyzed to identify phonemes 708 and visemes 709 that are associated with a speaking entity 710 within the movie or television show.

The analyzing module 711 of computer system 701 may then analyze the media item 727 to identify lip shape 712 and/or lip flap timing 713 for the entity during the key moments of the film or during the entire film. Lip shape of the speaking entity may represent visemes that correspond to one or more potential phonemes being produced by the speaking person. Lip shape may change, frame by frame, and, as such, the analyzing module 711 may be configured to analyze each frame of a specified moment in order to determine how the speaking person's lip shape changes in each frame and which set of phonemes are likely being made by the speaking person in each frame.

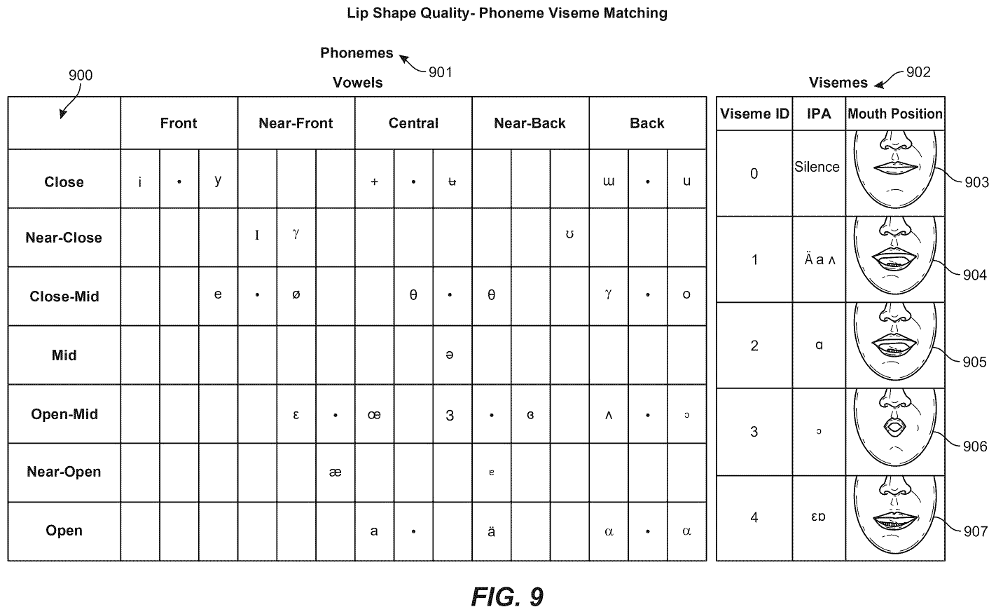

Similarly, lip flap timing 713 may indicate which set of phonemes are likely being made by a speaking entity 710. Lip flap timing may indicate, for each moment, how quickly or slowly the speaker's lips are moving. These indications of timing can rule out certain sounds and can indicate other sounds that are highly likely to be produced. When taken together, lip shape 712 and lip flap timing 713 can provide a high degree of confidence that a certain phoneme is being produced by the speaking person. This will be discussed in greater detail with regard to FIG. 9.

The comparison module 714 of computer system 701 may be configured to compare the identified lip shape 712 and/or lip flap timing 713 to the accessed phonemes 708 and visemes 709. The phonemes 708 may correspond to the original audio or the dubbed audio, while the visemes 709 will correspond to the original video (unless the video is being edited in the dubbed version). At least in some cases, the comparison module 714 may be designed to identify differences between the phonemes of the dubbed audio and the lip shape 712 and/or lip flap timing 713 of the speaking person. If the timing between the phonemes 708 of the dubbed audio and the lip shape or lip flap timing is off, the comparison module 714 will indicate, in the comparison results 715, that the dub quality is low.

If, however, if the timing between the phonemes 708 of the dubbed audio and the lip shape or lip flap timing is closely aligned, the comparison module 714 will indicate, in the comparison results 715, that the dub quality is high. The dubbing evaluation result generating module 718 may look at the comparison results and generate a dubbing evaluation result 721 for the media item and for that dub specifically (e.g., the dub for each language may receive its own analysis and its own dubbing evaluation result). The dubbing evaluation result may then be used by dub artists (e.g., 723) and potentially by automated systems (e.g., 722) to refine the existing dub or to create a new dub. This dub (and potentially other changes) may be provided to the computer system 701 as input 724. These concepts will be described in greater detail with respect to method 800 of FIG. 8 and FIGS. 7-11B below.

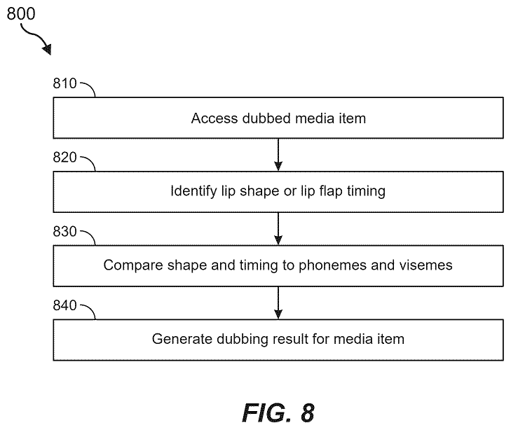

FIG. 8 is a flow diagram of an exemplary computer-implemented method 800 for providing dubbing evaluation results or dubbing scores for dubs that have been generated for a media item. The steps shown in FIG. 8 may be performed by any suitable computer-executable code and/or computing system, including the systems illustrated in FIG. 7. In one example, each of the steps shown in FIG. 8 may represent an algorithm whose structure includes and/or is represented by multiple sub-steps, examples of which will be provided in greater detail below.

Method 800 includes, at 810, a step for accessing a media item (e.g., 727 of FIG. 7) that has been dubbed into a secondary language. The media item 727 includes phonemes 708 and corresponding visemes 709 associated with different specified moments when an entity (e.g., an actor, actress, or other person or animated character, etc.) is speaking. The method 800 next includes, at step 820, analyzing the media item 727 to identify lip shape 712 and/or lip flap timing 713 for the speaking entity 710 during the various moments in the media item in which the entity is speaking. Then, at step 830, the method 800 includes comparing, for at least one of the specified moments in the media item, the identified lip shape 712 and/or the identified lip flap timing 713 to the accessed phonemes 708 and/or visemes 709. Still further, at step 840, method 800 includes generating a dubbing evaluation result 721 for the media item 727 based on the comparison between lip shape and/or lip flap timing to the accessed phonemes and/or visemes for the specified moment(s) in the media item.

In some embodiments, a machine learning model may be trained and/or implemented to identify, for the specified moments and potentially for multiple other moments, which entity is actively speaking. That machine learning model may further be trained to map the visemes 709 to one or more of the phonemes 708 for the actively speaking entity 710. This mapping 717 between the visemes and phonemes of the actively speaking entity may be provided to the analyzing module 711 to assist in determining lip shape 712 and/or lip flap timing 713 or to perform the analysis for the analyzing module and provide the mapping 717 so that the analyzing module does not need to perform the analyzing.

It should be noted, as mentioned above, that at least some of the embodiments described herein may train and/or implement a machine learning model. For example, at least some embodiments herein may implement one or more machine learning algorithms to characterize objects identified in an image or series of images including moving lips and mouths, identify phonemes and/or visemes based on the identified objects, compare the phonemes and visemes to a dubbed version of the media item, generate dubbing evaluation result, and potentially provide recommendations to improve dub. In some cases, the systems herein may be configured to train machine learning models and/or neural networks to perform any or all of these steps.

In some examples, the systems herein may implement and/or incorporate a machine learning module that includes various ML-related components. These components may include a machine learning (ML) processor, an inferential model, a feedback implementation module, a prediction module, and/or a neural network (each of which may be included in the ML model training module 719, for example). Each of these components may be configured to perform different functions with respect to training and/or implementing a machine learning model. The ML processor, for example, may be a dedicated, special-purpose processor with logic and circuitry designed to perform machine learning. The ML processor may work in tandem with the feedback implementation module to access data and use feedback to train an ML model. For instance, the ML processor may access one or more different training data sets. The ML processor and/or the feedback implementation module may use these training data sets to iterate through positive and negative samples and improve the ML model over time.

In some cases, the machine learning module may include an inferential model. As used herein, the term “inferential model” may refer to purely statistical models, purely machine learning models, or any combination of statistical and machine learning models. Such inferential models may include neural networks such as recurrent neural networks. In some embodiments, the recurrent neural network may be a long short-term memory (LSTM) neural network. Such recurrent neural networks are not limited to LSTM neural networks and may have any other suitable architecture.

For example, in some embodiments, the neural network may be a fully recurrent neural network, a gated recurrent neural network, a recursive neural network, a Hopfield neural network, an associative memory neural network, an Elman neural network, a Jordan neural network, an echo state neural network, a second order recurrent neural network, and/or any other suitable type of recurrent neural network. In other embodiments, neural networks that are not recurrent neural networks may be used. For example, deep neural networks, convolutional neural networks, and/or feedforward neural networks, may be used. In some implementations, the inferential model may be an unsupervised machine learning model, e.g., where previous data (on which the inferential model was previously trained) is not required.

At least some of the embodiments described herein may include training a neural network to identify data dependencies, identify which information from various data sources is to be altered to lead to a desired outcome, or how to alter the information to lead to a desired outcome. In some embodiments, the systems described herein may include a neural network that is trained to identify how information is to be altered using different types of data and associated data dependencies. For example, the embodiments herein may use a feed-forward neural network. In some embodiments, some or all of the neural network training may happen offline. Additionally or alternatively, some of the training may happen online. In some examples, offline development may include feature and model development, training, and/or test and evaluation.

In one embodiment, a repository that includes data about past data accessed and past data alterations may supply the training and/or testing data. In one example, when the underlying system had accessed different types of data from different data sources, the system may determine which alterations to identify based on data from a feature repository and/or an online recommendation model that may be informed by the results of offline development. In one embodiment, the output of the machine learning model may include a collection of vectors of floats, where each vector represents a data source and each float within the vector represents the probability that a specified data alteration will be identified. In some embodiments, the recent history of a data source may be weighted higher than older history data. For example, if a data source had repeatedly provided relevant data that resulted in relevant operational steps, the ML model may determine that the probability of that data source providing relevant data in the future is higher than for other data sources.

Once the machine learning model has been trained, the ML model may be used to identify which data is to be altered and how that data is to be altered based on multiple different data sets. In some embodiments, the machine learning model that makes these determinations may be hosted on different cloud-based distributed processors (e.g., ML processors) configured to perform the identification in real time or substantially in real time. Such cloud-based distributed processors may be dynamically added, in real time, to the process of identifying data alterations. These cloud-based distributed processors may work in tandem with the prediction module to generate outcome predictions, according to the various data inputs.

These predictions may identify potential outcomes that would result from the identified data alterations. The predictions output by the prediction module may include associated probabilities of occurrence for each prediction. The prediction module may be part of a trained machine learning model that may be implemented using the ML processor. In some embodiments, various components of the machine learning module may test the accuracy of the trained machine learning model using, for example, proportion estimation. This proportion estimation may result in feedback that, in turn, may be used by the feedback implementation module in a feedback loop to improve the ML model and train the model with greater accuracy.

Thus, in FIG. 7, the ML model training module 719 may be configured to train a machine learning model 720 that is trained to map visemes 709 to phonemes 708 on a plurality of different media items (e.g., 726). The mapping process may analyze each frame of a video to determine which person is speaking, what position or shape that person's lips are in, whether or not the speaking person's lips are flapping and, if so, how often (i.e., identifying lip flap timing 713 as the person's lips change between frames). In some cases, this frame-by-frame analysis may be performed for the entire media item 727 or group of media items 726, while in other cases, the analysis may be performed solely for specified moments in the media items (i.e., those moments that have an importance level above a specified threshold value, based on contextual data). Past mappings and analyses may be used as feedback 716 to improve the ML model 720.

In some embodiments, the machine learning model 720 may be trained to identify the actively speaking entity's lip shape and correlate that lip shape or lip formation to different phonemes. For instance, as shown in FIG. 9, different types of phonemes 901 may correlate to different visemes 902. The chart 900 presents a plurality of different phonemes 901. These phonemes may be made when the speaker's mouth is closed, midway open, or fully open (or at other positions in between). Moreover, different sounds may be made (e.g., vowels or consonants) when the sound is produced at the front, center, or back of the speaking person's mouth (or at other points in between).

Thus, a wide range of sounds may be produced by a speaking person when the sound is made in a nearly closed position at the back of the person's mouth or at the center of the person's mouth in a fully open position. At least some of these phonemes 901 are represented in chart 900. The phonemes may be different in different languages and may correspond to the range of closed to open lip positions or front to back of the mouth positions. Thus, each language may be carefully studied to determine which phonemes are being made by a user and how those phonemes relate to lip shape, lip flap timing, or other mouth movements. As such, each title may be analyzed in its native language to determine phonemes for that language and to determine visemes that match those phonemes for that specific language.

In FIG. 9, five different visemes are presented, although it will be understood that substantially any number of visemes may be identified and documented. As noted above, the visemes may apply to a single, specific language, or the visemes may apply to many languages. The viseme 903 corresponds to a closed mouth, in which the person is silent. Viseme 904 corresponds to a certain grouping of sounds, while viseme 905 (which may be the same as or very similar to 904) may correspond to a different phoneme. Visemes 906 and 907 may each correspond to different phonemes. This process may be carried out for an entire movie or for key moments in the movie, identifying lip shape or lip movement and comparing that lip shape or movement to phonemes identified in the audio track. In this manner, the machine learning model 720 may learn a proper correspondence between visemes and phonemes.

That learned correspondence may then be applied to scoring dubs. The systems described herein may analyze dubbed audio and compare that audio to the visemes of the existing, original media item. If the alignment and correspondence between the dubbed audio and the underlying visemes is high, the dub result or dub score will be high, and the quality of the dub will be said to be outstanding. If, on the other hand, the alignment and correspondence between the dubbed audio and the underlying visemes is low or uneven, the dub result or dub score will be low, and the quality of the dub will be said to be poor. In this manner, a machine learning model may be trained to correlate lip shape and lip flap timing to phonemes in original media items and take that learned correlation and determine which dubs are of high quality and which are of lesser quality and should be recommended for redubbing.

In some cases, the machine learning model 720 may be trained to predict an implied lip shape based on a specified phoneme or even based on a dub transcript. In some cases, the machine learning model 720 may analyze the audio for a given media item and identify phonemes for the entire media item or for the recommended key moments described above. In some cases, based on historical data and the analysis of prior media items and their corresponding dubs, the machine learning model 720 may be trained to predict speaking users' lip shapes based on the specified phoneme. For instance, the machine learning model 720 may consult a chart similar to the chart 900 described in FIG. 9 for the language in which the movie was originally filmed. The machine learning model 720 may then analyze the audio of a dub in a secondary language and determine, for that dub, how the speaking person's lips should look and/or move. The machine learning model 720 may then attempt to align the predicted lip positions and/or movements with existing visemes in the media item. As such, the predicted lip positions and/or movements may be used to create a better alignment between the dubbed audio and the original visemes of the media item.

Additionally or alternatively, the machine learning model 720 may analyze a transcript of the dubbed audio and predict the speaking user's lip shape and/or lip movement based on the dubbed audio transcript. The machine learning model 720 may leverage text-to-speech models that indicate how different words are spoken in that language and which visemes are usually associated with those words and corresponding phonemes. In some cases, the transcript may be annotated with key moment flags that identify key moments that are to receive additional scrutiny when creating a dub. The machine learning model 720 may then analyze the dub transcript, particularly at the key moments, and predict which lip shapes and which lip movements the dub performing artist will make when reading the dub transcript. The model can then indicate, based on the prediction, whether the dub script should be modified or rewritten to better conform to the existing visemes (i.e., to better conform to the lip shapes and movements that are already recorded on the original video). This may save a great deal of time, as an entire round of voice recording may be avoided if the predictions of lip and mouth movements indicate that they will not align with or match the existing visemes of the media item.

In some cases, the machine learning model 720 may implement data from encoders that are configured to identify both lip shape and lip flap timing. In the embodiments described above, encoders may be used to read video data and prepare that data for display on a tv, phone, or other device. The encoders may be configured to render video frames and, in some cases, may be configured to identify lip shape and/or lip flap timing. The encoders may be configured to analyze differences in lip or mouth movements between consecutive video frames. These differences in lip placement or lip movements may indicate that specific phonemes are being spoken by the speaking entity.

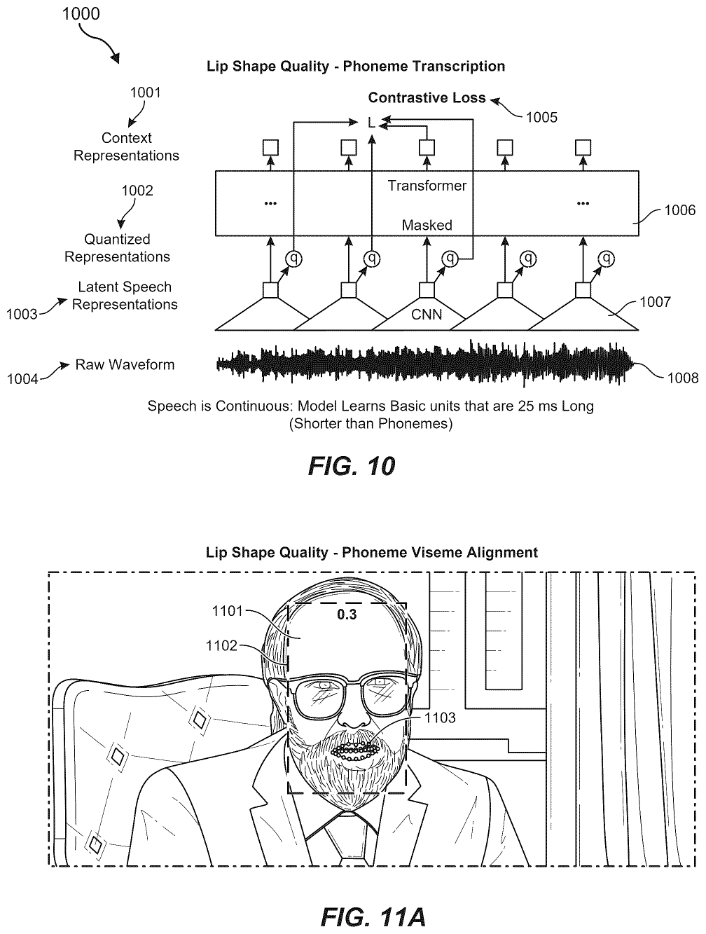

FIG. 10 illustrates an embodiment of a system 1000 configured to increase the quality of identified lip shapes (e.g., lip shapes 903-907 of FIG. 9). At least in some cases, phoneme transcriptions may be implemented to increase the quality of detected lip shapes. The system 1000 may receive, as an input, a raw waveform 1004. The raw waveform 1004 may be an analog waveform 1008 or a digital waveform. One or more different convolutional neural networks (CNNs) 1007 may be implemented to identify latent speech representations 1003 in the raw waveform 1004. The speech representations 1003 may be substantially any lip movement or lip shape that indicates that a phoneme is being formed. The latent speech representations 1003 may then be quantized (e.g., at 1002) and masked (e.g., at 1006) as part of a self-supervised model.

The self-supervised model may be trained by predicting discrete speech units (e.g., quantized speech units) for masked parts of the audio. The self-supervised model may then be fine tuned on a labeled data set with a connectionist temporal classification (CTC) for downstream speech recognition tasks. In this process, system 1000 may analyze context representations 1001 in conjunction with the quantized representations 1002 to identify a contrastive loss 1005. This contrastive loss 1005 may then be used to clearly identify phonemes from the input audio. At least in some cases, the speech may be continuously input into the system 1000. The system 1000 may be configured to learn basic units of a set duration (e.g., 15 ms 25 ms, 50 ms, 100 ms) (which, at least in some cases, is shorter than phonemes), providing increased granularity and increased accuracy when identifying phonemes from input audio.

In some cases, the machine learning model 720 may be configured to determine an amount of cross-attention between an encoded audio stream and an encoded video stream from the media item. The encoded audio stream may include audio data for a given shot, for a given scene, for a key moment, or for the entire movie. Similarly, the encoded video stream may include video data for a given video shot, for a given scene, for a key moment, or for the length of the media item. The machine learning model 720 may be programmed or designed to analyze the encoded audio stream and the encoded video stream to determine the amount of cross-attention between them by identifying phonemes in the audio data and by identifying corresponding visemes in the video data. The analysis may determine how well the phonemes and visemes are aligned, especially between dubbed audio and the original video frames. This, in turn, may be used to generate a dubbing evaluation result for a given dub.

As part of this process, the machine learning model 720 ingests, as a ground truth, an initial audio and video stream that corresponds to the media item 727 in its original, non-dubbed form. The identified phonemes and visemes of the initial audio and video stream will, in most cases, align with each other in a one-to-one manner. The machine learning model 720 may learn from these fully aligned phonemes and visemes, creating a model or library of phonemes that match the underlying visemes being shown in the original video. After learning from thousands or millions of original titles with original audio and video, the machine learning model 720 may be used to compare the learned, ground truth audio and video stream to the phonemes and visemes of a media item that has been dubbed into a secondary language. The machine learning model 720 may analyze each video frame to identify visemes and may analyze the dubbed audio to identify phonemes that are (ideally) supposed to match the visemes as closely as possible (even though the dub is in a secondary language). This comparison may look at the differences in phonemes and visemes to generate the dubbing evaluation result 721.

The dubbing evaluation result may indicate, for each frame, for each scene, for each key moment, and/or for each title how well the dubbed phonemes align with the existing visemes. Thus, at least in some cases, the dubbing evaluation result 721 may not just be a single score for the title, but may also include a breakdown of sub-scores for each frame, scene, key moment, etc. Thus, dubbing artists may know exactly where to focus their efforts on a redub. The dubbing artists may look at which key moments or which frames scored poorly and focus on those moments, frames, or scenes. The redub may also be analyzed in the same manner and, if the score is improved, the redub may be adopted for that scene or moment.

In some cases, the machine learning model's comparison between the ground truth audio and video stream and the phonemes and visemes of the media item may provide feedback indicating various changes that would improve the video scene or the key moment or would improve the machine learning model itself. In some cases, for instance, the machine learning model 720 may recommend a certain word or phrase in the secondary language whose phonemes may better align to the original video. In other cases, the machine learning model 720 may rewrite the dialogue for an entire scene or key moment. The rewritten dialogue may have been analyzed for phonemes whose predicted visemes would closely correspond to the existing visemes of the original media item. Thus, by creating new dialogue in the dubbed language, by predicting visemes for the predicted phonemes of the newly created dialogue, and by matching the predicted visemes to the predicted phonemes, the machine learning model 720 may create or propose new dialogue that maintains the intent of the original media item while more closely corresponding to the original visemes of the media item.

The feedback indicating changes that would improve the video scene or key moment may also be used to enhance the machine learning model 720. Those specific changes that could improve phoneme/viseme alignment in a given scene may be noted in the data store 725. Then, when similar scenes with similar dialogue are encountered at a later time, the rewritten dialogue or the other changes in phonemes may be applied (at least in some measure) to the newly analyzed media items that are, at least in some ways, similar. As such, this feedback may improve the effectiveness of the machine learning model 720 when analyzing future media items and when proposing new dubbed dialogue that may provide improved phoneme/viseme alignment. The machine learning model 720 may thus be updated or calibrated or refined using the generated feedback.

Additionally or alternatively, the dubbing evaluation result 721 may be provided to a dub generating entity such as a human dub artist. The dubbing evaluation result 721 may indicate to the dubbing artist which portions of the dub (e.g., which scenes or key moments) scored well and which portions of the dub may need some improvement. As such, the dubbing artist may focus his or her efforts on those portions of the dub that scored the lowest.

In some cases, the dubbing evaluation result generating module 718 of FIG. 7 may infer the dubbing evaluation result 721 implicitly based on various behavioral signals 728. In such cases, the dubbing evaluation result 721 may be inferred without a formal analysis comparing phonemes to existing visemes and may be further inferred without any specific indications of approval or disapproval by a viewing user. For instance, some dubbing evaluation results may be derived directly from a viewer's approval or disapproval (e.g., an explicit user rating). If the user explicitly rates the program highly and the program is dubbed, at least a portion of that high score may be attributed to a high-quality dub. Alternatively, at least in some cases, the dubbing evaluation result generating module 718 may infer the dubbing evaluation result 721 based on behavioral signals 728 instead of being based on explicit indications of approval or disapproval.

For example, if a user watches a dubbed video to completion, the user's watching of the full video may be a behavioral signal 728 that the dub is at least of reasonably high quality. If the viewer watches multiple episodes or multiple seasons of a dubbed television show, at least a portion of the viewer's behavior to return and fully watch subsequent episodes and seasons is an indirect, behavioral indicator of a good quality dub. If the viewer watches different shows also dubbed into the same or into a different secondary language, those views may also implicitly indicate the viewer's interest in the title and may indicate that the dub quality is sufficiently high. Alternatively, if multiple viewers leave after only a few minutes of viewing, before a certain proportion of the media item has been viewed, or if viewers do not return to later episodes and seasons, at least some of the viewer's disinterest may be attributable to a low-quality dub.

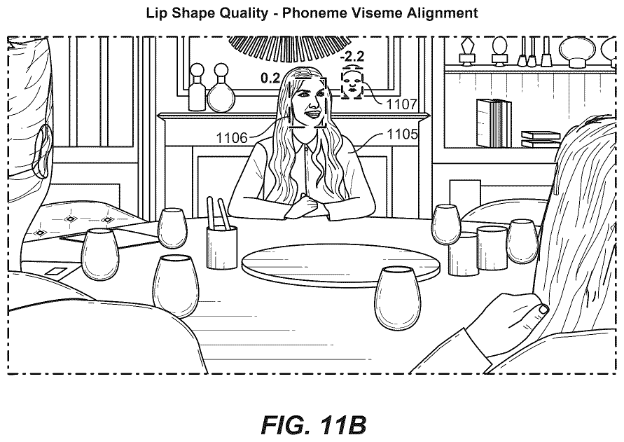

At least in some embodiments, whether the dubbing evaluation result is generated based on behavioral indicators or based on a determined level of alignment between dub phonemes and original visemes, the dubbing evaluation result may indicate the general quality of a dub. In cases where the dubbing evaluation result for a media item is below an established threshold value, the computer system 701 may initiate a redub of the media item. For instance, as shown in FIGS. 11A and 11B, if an actor's lips are readily visible (e.g., are well lit and are of a sufficiently large size), then the system may be more likely to identify the scene as a key moment in the media item. Moreover, the system may more easily establish phoneme/viseme alignment and may determine a more accurate score.

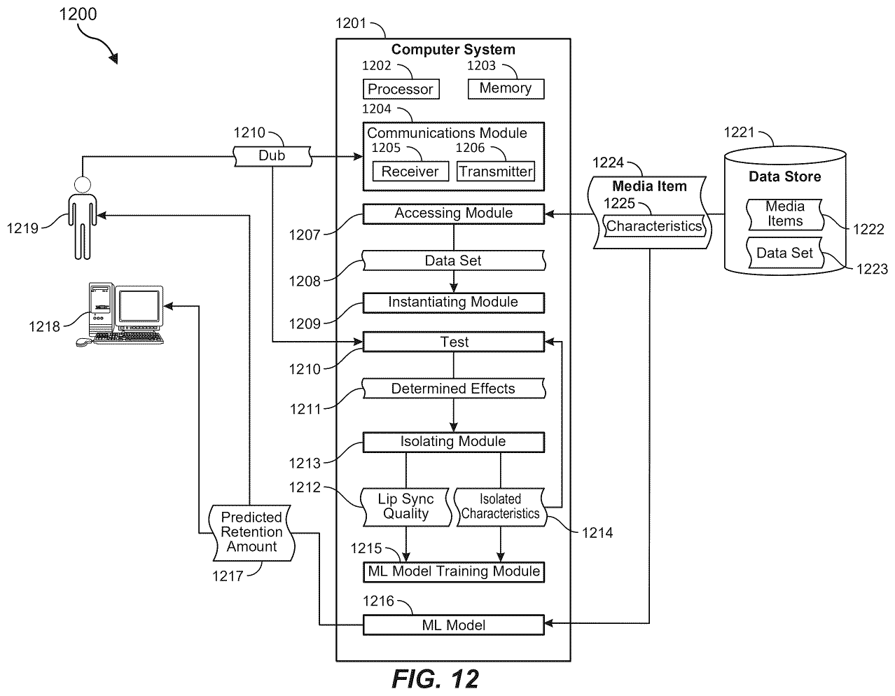

In FIG. 11A, for example, the actor's face 1101 fills up a defined area 1102, and the actor's lips 1103 are sufficiently visible to determine phoneme/viseme alignment with a high level of accuracy. As such, the scene depicted in FIG. 11A is more likely to be selected as a key moment that will receive increased scrutiny during the dub generation process. If, on the other hand, for example, the actress 1105 of FIG. 11B is further away from the camera, and her face 1106 and lips are not readily visible (e.g., 1107), the system will be less likely to identify the scene as a key moment and the scene will likely not receive increased scrutiny during the dubbing process After the dub has been created, the dub may be evaluated for phoneme/viseme alignment. If alignment is above a threshold value, the dub will be stored. If alignment is below the established threshold, the computer system 701 may initiate a redub for the media item, or at least for those key moments or scenes that scored below the threshold value. This process of generating a dubbing evaluation result and initiating a redub of media items may form a feedback loop that provides higher and higher quality dubs over time. Moreover, as will be explained further below with regard to FIG. 12, the dubbing evaluation result for a media item may be used to predict an amount by which a viewer will be more likely to view at least some part of a media item (or the full media item) because of a high dubbing score.

In addition to the above-described method, a corresponding system may be provided that includes at least one physical processor and physical memory comprising computer-executable instructions that, when executed by the physical processor, cause the physical processor to: access a media item that has been dubbed into a secondary language, the media item including one or more phonemes and one or more corresponding visemes associated with at least one moment when an entity is speaking, analyze the media item to identify lip shape and/or lip flap timing for the entity during the at least one moment in the media item in which the entity is speaking, for the at least one moment in the media item, compare the identified lip shape and/or the identified lip flap timing to the accessed phonemes and/or visemes and generate a dubbing evaluation result for the media item based on the comparison between lip shape and/or lip flap timing to the accessed phonemes and/or visemes for the at least one moment in the media item.

Still further, a corresponding non-transitory computer-readable medium may be provided that includes one or more computer-executable instructions that, when executed by at least one processor of a computing device, cause the computing device to: access a media item that has been dubbed into a secondary language, the media item including one or more phonemes and one or more corresponding visemes associated with at least one moment when an entity is speaking, analyze the media item to identify lip shape and/or lip flap timing for the entity during the at least one moment in the media item in which the entity is speaking, for the at least one moment in the media item, compare the identified lip shape and/or the identified lip flap timing to the accessed phonemes and/or visemes, and generate a dubbing evaluation result for the media item based on the comparison between lip shape and/or lip flap timing to the accessed phonemes and/or visemes for the at least one moment in the media item.

FIG. 12, for example, illustrates a computing environment 1200 in which the computer system may indicate by how much an improvement to lip synchronization will improve viewer retention of a media item. FIG. 12 includes various electronic components and elements including a computer system 1201 that is used, alone or in combination with other computer systems, to perform associated tasks. The computer system 1201 may be substantially any type of computer system including a local computer system or a distributed (e.g., cloud) computer system. The computer system 1201 includes at least one processor 1202 and at least some system memory 1203. The computer system 1201 includes program modules for performing a variety of different functions. The program modules may be hardware-based, software-based, or may include a combination of hardware and software. Each program module uses computing hardware and/or software to perform specified functions, including those described herein below.

In some cases, the communications module 1204 is configured to communicate with other computer systems. The communications module 1204 includes substantially any wired or wireless communication means that can receive and/or transmit data to or from other computer systems. These communication means include, for example, hardware radios such as a hardware-based receiver 1205, a hardware-based transmitter 1206, or a combined hardware-based transceiver capable of both receiving and transmitting data. The radios may be WIFI radios, cellular radios, Bluetooth radios, global positioning system (GPS) radios, or other types of radios. The communications module 1204 is configured to interact with databases, mobile computing devices (such as mobile phones or tablets), embedded computing systems, or other types of computing systems.

The computer system 1201 further includes an accessing module 1207. The accessing module 1207 may be configured to access different types of data associated with different media items. For example, various data sets 1223 may be associated with media items 1222 stored in data store 1221. The data sets 1223 may indicate a media item's size, length, title name, actor or actress names, resolution, encoding information, dubbing information, original language indicator, number of times the media item has been viewed, countries in which the media item is available for viewing, or other information related to the media item.

This data set 1208 accessed by the accessing module 1207 may be used by the instantiating module 1209 to instantiate a test 1210. The test 1210 may be designed to determine, based on the different types of data in the data set 1208, which media item characteristics 1225 affect how a given media item (e.g., media item 1224) is received by users that have access to the media item. For instance, the media item may be highly popular and may be viewed by many thousands or millions of people. Alternatively, the media item 1224 may be less popular and may only be viewed occasionally. Or, the media item may be started by many people and finished to completion, or the media item may be started by many viewers and abandoned by many viewers only a few minutes into playback. At least in some cases, the quality of the dub associated with a media item may contribute to how well the media item is received by viewers and how well the media item retains viewers throughout its runtime. As such, the embodiments herein may establish probative tests to determine how much improvements to dubs or improvements to lip synchronization on the whole will affect viewer retention.

To more precisely determine the effects 1221 of dub quality or lip synchronization on viewer retention of a media item, the probative test 1210 may isolate multiple media item characteristics 1225 that affect how the media item is received by users, while omitting lip sync quality 1212 from the isolated media item characteristics 1214. The isolating module 1213 may isolate original language or actress names or other characteristics to see how those characteristics affect viewer retention (i.e., how those characteristics influence whether a viewer will watch the entire media item or at least a minimum specified percentage of the title (e.g., 80%, 85%, 90%, etc.) or a minimum specified number of minutes of the title (e.g., 60 min., 70 min., 80 min., 90 min., etc.)). Such indications let the producer or creator or provider of the media item know whether the media item holds the viewer's interest and, if not, what the causes of that trailing interest may be. In some cases, these indications may be further used to predict how much a change in the quality of a second-language dub or an improvement in lip synchronization will affect viewer retention of a media item. This process will be described in greater detail with respect to method 1300 of FIG. 13 and FIGS. 12-18 below.

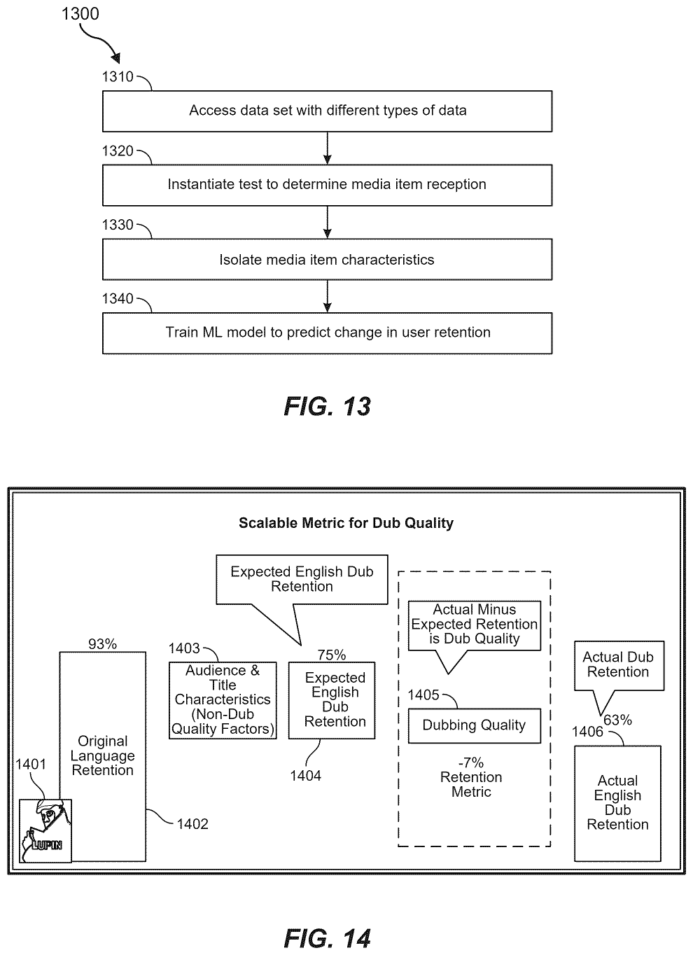

FIG. 13 is a flow diagram of an exemplary computer-implemented method 1300 for indicating by how much an improvement to lip synchronization will improve viewer retention of a media item. The steps shown in FIG. 13 may be performed by any suitable computer-executable code and/or computing system, including the systems illustrated in FIG. 12. In one example, each of the steps shown in FIG. 13 may represent an algorithm whose structure includes and/or is represented by multiple sub-steps, examples of which will be provided in greater detail below.

Method 1300 includes, at 1310, a step for accessing a data set 1223 that includes a plurality of different types of data for a specified media item (e.g., 1224). Next, at step 1320, method 1300 includes instantiating a probative test 1210 to determine, based on the different types of data, which media item characteristics 1225 affect how the media item 1224 is received by users that have played back the media item (e.g., user 1219). Then, at step 1330 and as part of the probative test 1210, the method 1300 includes isolating multiple media item characteristics 1214 that affect how the media item is received by users. In this step, lip sync quality may be omitted from the isolated media item characteristics 1214. This allows lip sync quality 1212 to be empirically evaluated on its effect 1211 on retaining viewers throughout the duration of the media item 1224. The method 1300 also includes, at step 1340, training a machine learning model 1216 (e.g., using the ML model training module 1215 of computer system 1201), using the isolated media item characteristics 1214, to predict an amount by which user retention will be affected based on a specified amount of change in lip sync quality 1212. This predicted amount 1218 may be provided to various entities including computer system 1218 and/or user 1219.

Thus, at least in some embodiments, the ML model 1216 may be trained to analyze past media items that were previously made available to viewers (e.g., media items that were posted and promulgated on a media streaming service (e.g., a movie and television streaming service, a podcast streaming service, a video game streaming service, etc.)). From this analysis, and by isolating other characteristics (e.g., actors or actresses in a movie, title length, genre, originating country and language, dubbed language, etc.), the ML model 1216 may learn how much the quality of a title's lip sync affects viewer retention. That is, the ML model 1216 may determine whether viewers were turned off by a title's poor lip sync quality or kept watching the title because of the title's high-quality lip sync. This baseline knowledge may then be used by the ML model to predict an amount by which user retention would be affected based on a specified amount of change in lip sync quality 1212 for a given title.

In the embodiments above, specific moments may be identified in a media item during which lip sync may be of higher importance (e.g., zoomed in, well-lit shots that prominently feature a person's face and mouth). Moreover, the systems herein may evaluate second-language dubs to determine the quality of the dub on a frame-by-frame basis, applying additional focus to those specified moments in the media item. These features may also be used when predicting an amount by which user retention would be affected based on a change in lip sync quality 1212. The effect on viewers may account for the specified, key moments in which it is more important to have high-quality lip sync. Moreover, the effect (or predicted effect) on viewer retention may also take into consideration the dubbing evaluation result for the media item. If the dubbing score is low, the prediction will likely indicate that an increase in lip sync quality would highly affect the title's viewer retention. In other words, the predicted retention amount 1217 generated by the ML model 1216 would likely be higher for media items that had poor dubbing scores and, specifically, media items that had poor dubbing scores at one or more of the key moments in the title.

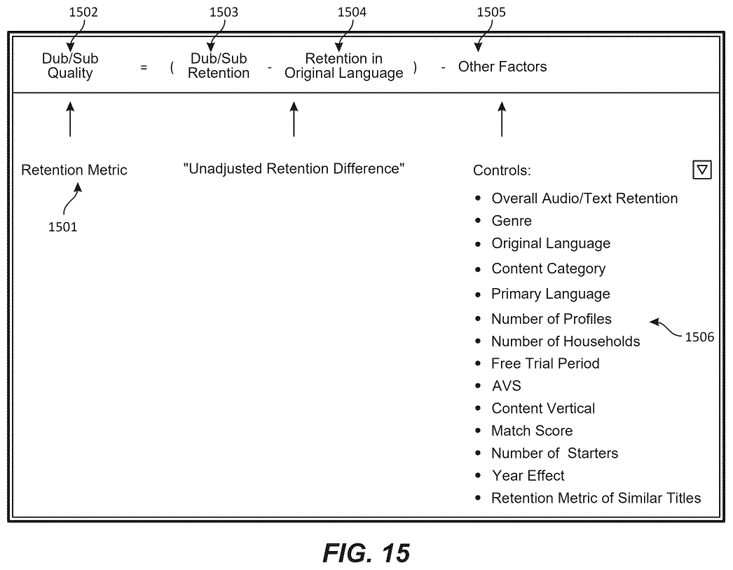

FIGS. 14 and 15 illustrate embodiments in which scalable, success metrics may be identified for determining dub quality. In some cases, the amount by which user retention will be affected based on a specified amount of change in lip sync quality is a success metric associated with the media item. The success metric may indicate the quality of the dub based on phoneme/viseme alignment determinations and/or based on how the media item performs on a streaming service (e.g., do viewers watch a media title to completion, do viewers watch beyond a given proportion of the media title, or do viewers come back for subsequent television episodes or seasons?).

FIG. 14 illustrates an embodiment of a television program, “Lupin” 1401. The computer system 1201 of FIG. 12 may be configured to determine how many or what percentage of viewers are retained when the title is presented in its original language. In this case, the title retains 93% of its viewers (e.g., across single episodes or across multiple episodes or seasons). During this analysis, the computer system 1201 may look at audience and title characteristics 1403 that may not be related to second-language dubs or lip sync quality in general.

FIG. 15 provides examples of such audience and title characteristics for which controls may be established. These controls 1506 attempt to encircle the other reasons why a viewer might not finish watching a media item. These controls 1506 may include, but are not limited to, non-dub media characteristics such as: overall audio & text retention, genre, original language, content category, primary language, number of profiles in the viewer's membership, number of households in the viewer's membership, whether the viewer is in a free trial period, audio video system (AVS) hardware, content vertical, match score, number of starters, year produced, retention metric of similar titles, or other characteristics. As FIG. 15 notes, a retention metric 1501 may be equal to the dub quality 1502, or the dub retention score 1503 minus the percentage of retention in the original language 1504 minus other factors 1505, including controls 1506. This retention metric 1501 thus controls for many other factors that may influence the retention of a viewer and focuses on how the quality of the dub, specifically, will affect viewer retention.

Returning to FIG. 14, after determining the original language retention amount 1402, and after controlling for audience (viewer) and title characteristics 1403, the computer system 1201 and/or ML model 1216 may identify the expected English dub retention 1404 (in this example, English is not the original language). The computer system 1201 and/or the ML model may then determine actual retention by determining a dubbing quality score 1405 and subtract the expected retention from the actual, original language retention amount 1402. The actual retention due to the dub, after isolating other media item characteristics, is the retention 1406 that is due to the quality of the dub. In this manner, the systems herein can determine what percentage of viewers stayed for the whole movie or returned for following episodes solely (or closely) based on the viewer's experience with the dubbed second language (i.e., based on the dubbing quality score 1405).

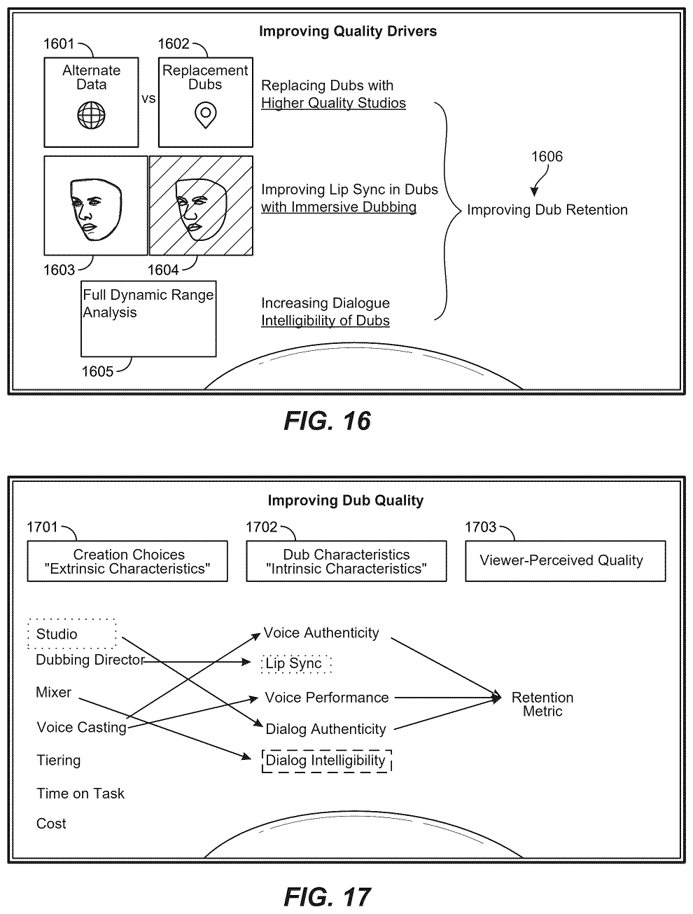

FIGS. 16-18 illustrate embodiments in which dub quality drivers may be used to improve dub quality, and where validation may be used as part of a feedback model to improve dub quality and improve viewer retention. FIG. 16 illustrates an embodiment in which quality drivers may be recognized and each, individually, improved in order to improve dub retention 1606. For instance, as noted above, these quality drivers may include voice acting quality, voice actor match, dialogue clarity, overall audio clarity, dialogue naturalness, dialogue audio quality, translation match, and other lip sync quality drivers.

In some embodiments, for instance, an existing dub 1601 may be replaced with a higher quality studio dub 1602 that was recorded using professional equipment. Or, modified dubs may be created in which an actress's face (without scanning in 1603) is scanned to better identify changes in lip shape and/or lip flap timing. As a result, the modified dubbing 1604 may be more accurate and may induce greater viewer retention 1606 due to lip sync quality (and/or the dub specifically). Still further, at least in some cases, the systems herein may perform a full dynamic range analysis 1605. The full dynamic range analysis 1605 may analyze speech patterns and voice changes over a variety of sonic frequencies. In some cases, edits may be made to the dub to increase the intelligibility of the dub's words based on the full dynamic range analysis 1605. Other changes may be made to other lip sync quality drivers, each of which may incrementally boost the dub retention metric 1606.

FIG. 17 illustrates an embodiment in which dub quality may be improved to ultimately improve the retention metric for the media item. In some cases, when the dub is created, various extrinsic characteristics 1701 may be identified and focused on when creating the dub. These may include choice of studio, choice of dubbing director, who is chosen for voice casting, how voice tiering is performed, how much time is spent on each moment when creating the dub for the title, and the overall cost or amount spent on the dub. Other intrinsic characteristics 1702 may include improvements to voice authenticity, lip sync, voice performance of the dub recorder, dialogue authenticity, and dialog intelligibility. Improvements in any one or more of these areas (e.g., 1701 and/or 1702) may improve the viewer-perceived quality 1703 (i.e., the retention or success metric).

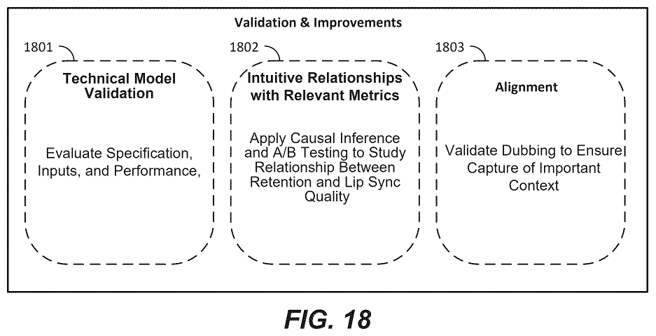

Then, after improvements have been made to the dub quality, validation models may be implemented to ensure that the improvements were substantive and had the desired effect. For instance, as shown in FIG. 18, a technical model 1801 may be implemented to validate the underlying specification, inputs, and performance of the dub quality improvement models being implemented. This process may involve determining relationships 1802 between retention and lip sync quality and may use causal inference and A/B testing to identify these relationships and associated metrics. At 1803, the system may validate existing dubbing to ensure that relevant contextual information (e.g., genre, shot type, etc.) has been captured when focusing on specific moments for creating a close phoneme/viseme alignment.

The probative tests described above, as well as the A/B tests of block 1802, may be probative in the sense that they are designed to determine specific effects or outcomes. In this example, the probative tests are designed to determine the effect that dubbing quality has had on previous media items, and then predict how dub quality for a new media item will affect viewer retention for that title. The A/B tests may be performed using different levels of lip sync quality. One version of the media item may have higher lip sync quality, while the other version of the same media item has lower lip sync quality. The system may then determine viewer retention for both versions of the media item and determine whether (and how much) lip sync quality affected viewer retention. This validation process of using A/B tests to determine how lip sync quality affects viewer retention may control for other variables to focus on lip sync quality specifically. The system may then analyze the results of the A/B tests and calibrate the underlying model(s) (e.g., the trained machine learning model 1216 of FIG. 12) using the results of the A/B tests.

In some cases, the trained machine learning model 1216 may use the results of the A/B tests to predict the amount by which viewer retention will be affected based on a specified amount of change in lip sync quality. Thus, the ML model 1216 may determine, based on an input from a user (e.g., input 122 of FIG. 1 or 724 of FIG. 7) indicating a specific amount of change in lip sync quality (e.g., a 10% improvement), how much viewer retention for that media item will be affected (e.g., 7% improvement in retention). The dubbing evaluation result (e.g., 118 of FIG. 1) may be used to determine whether a title has little room for improvement or a great deal of room for improvement (e.g., a low dubbing score). If the title has a large amount of room for improvement, and the ML model 1216 predicts a large increase in viewer retention (e.g., 15%), then the system may determine that a new dub is to be created for the title. This process may form a feedback loop for the machine learning model, where the feedback loop receives, as inputs, new media items with lip sync quality indicators (e.g., dubbing evaluation result 118) and predicts, based on comparisons to previous media items, how much lip sync quality improvements will affect viewer retention of that title.

In some embodiments, the probative test 1210 of FIG. 12 may be designed to compare user retention of a media item in its original language (e.g., Korean) to user retention of the media item in the dubbed, secondary language (e.g., English). In this example, the probative test would determine the user retention of the media item in Korean (e.g., how many viewers of the Korean media item were retained at least X number of minutes or how many viewers returned for subsequent episodes or seasons). The probative test 1210 may then determine user retention of the media item in the dubbed, secondary language which, in this case, is English. The test may then identify the difference or “gap size” between the user retention of the media item in its original language (Korean) and the user retention of the media item in the dubbed, secondary language (English). The size of the gap may indicate that the dub quality is poor and is leading to low retention, or that the dub quality is high and is leading to high retention.

In some cases, the machine learning model 1216 may be trained to predict the amount by which user retention will be affected based on the specified amount of change in lip sync quality for multiple different media items consumed by one specific user (e.g., user 1219). In other cases, the machine learning model 1216 may be trained to predict the amount by which user retention will be affected based on the specified amount of change in lip sync quality for multiple different users that have consumed a specific media item. In this manner, the ML model 1216 may look at how one viewer or how one group of viewers interacts with various titles or may look at the same title with different viewers watching from viewers that reside in different countries that speak different languages. The system may then isolate out cultural affinity, member taste, title performance, location, genre, and other variables in order to then determine which portion of the viewer retention gap is attributable to lip sync quality.

Still further, at least in some embodiments, the probative test 1210 may additionally compare user retention of the media item in its original language (e.g., Spanish) to user retention of the media item in a dubbed, tertiary language (e.g., Polish) that is different than the secondary language (e.g., French). The probative test 1210 may then identify a gap size between the viewer retention of the media item (e.g., 1224) in its original language (Spanish) and the user retention of the media item in the dubbed, secondary language (French) and in the dubbed, tertiary language (Polish). In this manner, the probative test 1210 may determine how each dub in a variety of different languages is performing relative to the original program with regard to viewer retention. Those dubs of sufficiently low quality that are leading to poor viewer retention in secondary, tertiary, or other languages may be redubbed in order to improve viewer retention.

In addition to the above-described method, a corresponding system may be provided. The system may include at least one physical processor and physical memory comprising computer-executable instructions that, when executed by the physical processor, cause the physical processor to: access a data set that includes a plurality of different types of data for a specified media item, instantiate a probative test to determine, based on the different types of data, which media item characteristics affect how the media item is received by users that have played back the media item, as part of the probative test, isolate a plurality of media item characteristics that affect how the media item is received by users, wherein lip sync quality is omitted from the plurality of isolated media item characteristics, and train a machine learning model, using the isolated media item characteristics, to predict an amount by which user retention will be affected based on a specified amount of change in lip sync quality.

Still further, a corresponding non-transitory computer-readable medium may be provided that includes one or more computer-executable instructions that, when executed by at least one processor of a computing device, cause the computing device to: access a data set that includes a plurality of different types of data for a specified media item, instantiate a probative test to determine, based on the different types of data, which media item characteristics affect how the media item is received by users that have played back the media item, as part of the probative test, isolate a plurality of media item characteristics that affect how the media item is received by users, wherein lip sync quality is omitted from the plurality of isolated media item characteristics, and train a machine learning model, using the isolated media item characteristics, to predict an amount by which user retention will be affected based on a specified amount of change in lip sync quality.

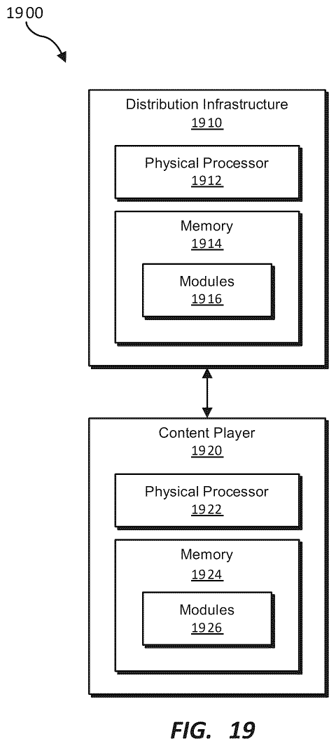

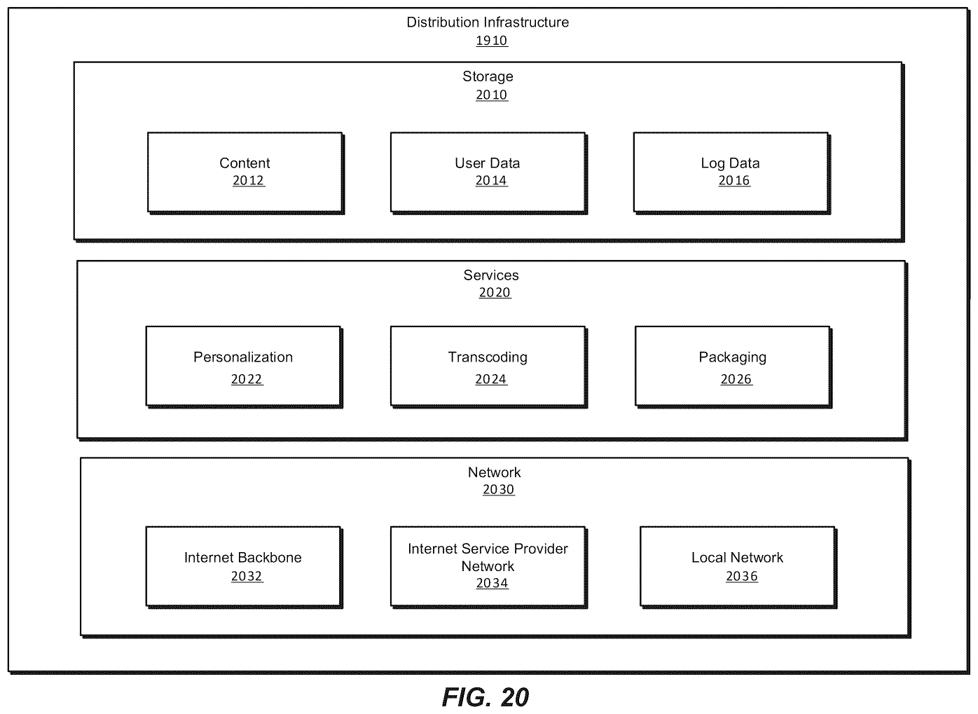

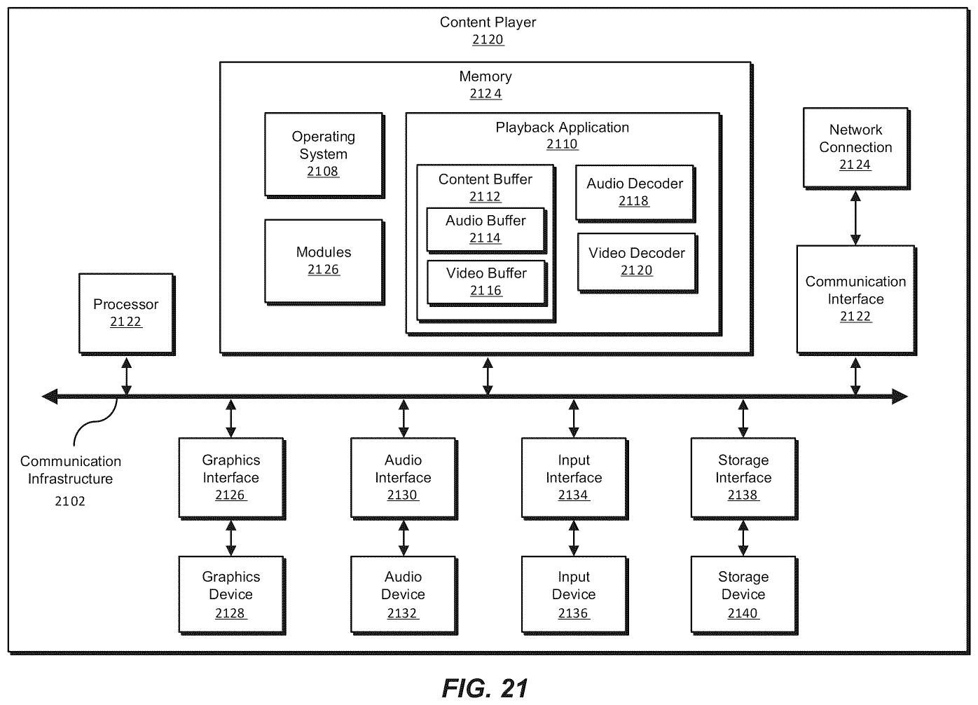

The following will provide, with reference to FIG. 19, detailed descriptions of exemplary ecosystems in which content is provisioned to end nodes and in which requests for content are steered to specific end nodes. The discussion corresponding to FIGS. 20 and 21 presents an overview of an exemplary distribution infrastructure and an exemplary content player used during playback sessions, respectively. These exemplary ecosystems and distribution infrastructures are implemented in any of the embodiments described above with reference to FIGS. 1-18.

FIG. 19 is a block diagram of a content distribution ecosystem 1900 that includes a distribution infrastructure 1910 in communication with a content player 1920. In some embodiments, distribution infrastructure 1910 is configured to encode data at a specific data rate and to transfer the encoded data to content player 1920. Content player 1920 is configured to receive the encoded data via distribution infrastructure 1910 and to decode the data for playback to a user. The data provided by distribution infrastructure 1910 includes, for example, audio, video, text, images, animations, interactive content, haptic data, virtual or augmented reality data, location data, gaming data, or any other type of data that is provided via streaming.

Distribution infrastructure 1910 generally represents any services, hardware, software, or other infrastructure components configured to deliver content to end users. For example, distribution infrastructure 1910 includes content aggregation systems, media transcoding and packaging services, network components, and/or a variety of other types of hardware and software. In some cases, distribution infrastructure 1910 is implemented as a highly complex distribution system, a single media server or device, or anything in between. In some examples, regardless of size or complexity, distribution infrastructure 1910 includes at least one physical processor 1912 and at least one memory device 1914. One or more modules 1916 are stored or loaded into memory 1914 to enable adaptive streaming, as discussed herein.

Content player 1920 generally represents any type or form of device or system capable of playing audio and/or video content that has been provided over distribution infrastructure 1910. Examples of content player 1920 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1910, content player 1920 includes a physical processor 1922, memory 1924, and one or more modules 1926. Some or all of the adaptive streaming processes described herein is performed or enabled by modules 1926, and in some examples, modules 1916 of distribution infrastructure 1910 coordinate with modules 1926 of content player 1920 to provide adaptive streaming of digital content.

In certain embodiments, one or more of modules 1916 and/or 1926 in FIG. 19 represent one or more software applications or programs that, when executed by a computing device, cause the computing device to perform one or more tasks. For example, and as will be described in greater detail below, one or more of modules 1916 and 1926 represent modules stored and configured to run on one or more general-purpose computing devices. One or more of modules 1916 and 1926 in FIG. 19 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1912 and 1922 generally represent any type or form of hardware-implemented processing unit capable of interpreting and/or executing computer-readable instructions. In one example, physical processors 1912 and 1922 access and/or modify one or more of modules 1916 and 1926, respectively. Additionally or alternatively, physical processors 1912 and 1922 execute one or more of modules 1916 and 1926 to facilitate adaptive streaming of digital content. Examples of physical processors 1912 and 1922 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1914 and 1924 generally represent any type or form of volatile or non-volatile storage device or medium capable of storing data and/or computer-readable instructions. In one example, memory 1914 and/or 1924 stores, loads, and/or maintains one or more of modules 1916 and 1926. Examples of memory 1914 and/or 1924 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 20 is a block diagram of exemplary components of content distribution infrastructure 1910 according to certain embodiments. Distribution infrastructure 1910 includes storage 2010, services 2020, and a network 2030. Storage 2010 generally represents any device, set of devices, and/or systems capable of storing content for delivery to end users. Storage 2010 includes a central repository with devices capable of storing terabytes or petabytes of data and/or includes distributed storage systems (e.g., appliances that mirror or cache content at Internet interconnect locations to provide faster access to the mirrored content within certain regions). Storage 2010 is also configured in any other suitable manner.

As shown, storage 2010 may store a variety of different items including content 2012, user data 2014, and/or log data 2016. Content 2012 includes television shows, movies, video games, user-generated content, and/or any other suitable type or form of content. User data 2014 includes personally identifiable information (PII), payment information, preference settings, language and accessibility settings, and/or any other information associated with a particular user or content player. Log data 2016 includes viewing history information, network throughput information, and/or any other metrics associated with a user's connection to or interactions with distribution infrastructure 1910.

Services 2020 includes personalization services 2022, transcoding services 2024, and/or packaging services 2026. Personalization services 2022 personalize recommendations, content streams, and/or other aspects of a user's experience with distribution infrastructure 1910. Encoding services 2024 compress media at different bitrates which, as described in greater detail below, enable real-time switching between different encodings. Packaging services 2026 package encoded video before deploying it to a delivery network, such as network 2030, for streaming.

Network 2030 generally represents any medium or architecture capable of facilitating communication or data transfer. Network 2030 facilitates communication or data transfer using wireless and/or wired connections. Examples of network 2030 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 20, network 2030 includes an Internet backbone 2032, an internet service provider 2034, and/or a local network 2036. As discussed in greater detail below, bandwidth limitations and bottlenecks within one or more of these network segments triggers video and/or audio bit rate adjustments.

FIG. 21 is a block diagram of an exemplary implementation of content player 1920 of FIG. 19. Content player 1920 generally represents any type or form of computing device capable of reading computer-executable instructions. Content player 1920 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 21, in addition to processor 1922 and memory 1924, content player 1920 includes a communication infrastructure 2102 and a communication interface 2122 coupled to a network connection 2124. Content player 1920 also includes a graphics interface 2126 coupled to a graphics device 2128, an input interface 2134 coupled to an input device 2136, and a storage interface 2138 coupled to a storage device 2140.

Communication infrastructure 2102 generally represents any type or form of infrastructure capable of facilitating communication between one or more components of a computing device. Examples of communication infrastructure 2102 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1924 generally represents any type or form of volatile or non-volatile storage device or medium capable of storing data and/or other computer-readable instructions. In some examples, memory 1924 stores and/or loads an operating system 2108 for execution by processor 1922. In one example, operating system 2108 includes and/or represents software that manages computer hardware and software resources and/or provides common services to computer programs and/or applications on content player 1920.

Operating system 2108 performs various system management functions, such as managing hardware components (e.g., graphics interface 2126, audio interface 2130, input interface 2134, and/or storage interface 2138). Operating system 2108 also provides process and memory management models for playback application 2110. The modules of playback application 2110 includes, for example, a content buffer 2112, an audio decoder 2118, and a video decoder 2120.

Playback application 2110 is configured to retrieve digital content via communication interface 2122 and play the digital content through graphics interface 2126. Graphics interface 2126 is configured to transmit a rendered video signal to graphics device 2128. In normal operation, playback application 2110 receives a request from a user to play a specific title or specific content. Playback application 2110 then identifies one or more encoded video and audio streams associated with the requested title. After playback application 2110 has located the encoded streams associated with the requested title, playback application 2110 downloads sequence header indices associated with each encoded stream associated with the requested title from distribution infrastructure 1910. A sequence header index associated with encoded content includes information related to the encoded sequence of data included in the encoded content.

In one embodiment, playback application 2110 begins downloading the content associated with the requested title by downloading sequence data encoded to the lowest audio and/or video playback bitrates to minimize startup time for playback. The requested digital content file is then downloaded into content buffer 2112, which is configured to serve as a first-in, first-out queue. In one embodiment, each unit of downloaded data includes a unit of video data or a unit of audio data. As units of video data associated with the requested digital content file are downloaded to the content player 1920, the units of video data are pushed into the content buffer 2112. Similarly, as units of audio data associated with the requested digital content file are downloaded to the content player 1920, the units of audio data are pushed into the content buffer 2112. In one embodiment, the units of video data are stored in video buffer 2116 within content buffer 2112 and the units of audio data are stored in audio buffer 2114 of content buffer 2112.

A video decoder 2120 reads units of video data from video buffer 2116 and outputs the units of video data in a sequence of video frames corresponding in duration to the fixed span of playback time. Reading a unit of video data from video buffer 2116 effectively de-queues the unit of video data from video buffer 2116. The sequence of video frames is then rendered by graphics interface 2126 and transmitted to graphics device 2128 to be displayed to a user.

An audio decoder 2118 reads units of audio data from audio buffer 2114 and outputs the units of audio data as a sequence of audio samples, generally synchronized in time with a sequence of decoded video frames. In one embodiment, the sequence of audio samples is transmitted to audio interface 2130, which converts the sequence of audio samples into an electrical audio signal. The electrical audio signal is then transmitted to a speaker of audio device 2132, which, in response, generates an acoustic output.

In situations where the bandwidth of distribution infrastructure 1910 is limited and/or variable, playback application 2110 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 2126 is configured to generate frames of video data and transmit the frames of video data to graphics device 2128. In one embodiment, graphics interface 2126 is included as part of an integrated circuit, along with processor 1922. Alternatively, graphics interface 2126 is configured as a hardware accelerator that is distinct from (i.e., is not integrated within) a chipset that includes processor 1922.

Graphics interface 2126 generally represents any type or form of device configured to forward images for display on graphics device 2128. For example, graphics device 2128 is fabricated using liquid crystal display (LCD) technology, cathode-ray technology, and light-emitting diode (LED) display technology (either organic or inorganic). In some embodiments, graphics device 2128 also includes a virtual reality display and/or an augmented reality display. Graphics device 2128 includes any technically feasible means for generating an image for display. In other words, graphics device 2128 generally represents any type or form of device capable of visually displaying information forwarded by graphics interface 2126.

As illustrated in FIG. 21, content player 1920 also includes at least one input device 2136 coupled to communication infrastructure 2102 via input interface 2134. Input device 2136 generally represents any type or form of computing device capable of providing input to content player 1920. Examples of input device 2136 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 2120 also includes a storage device 2140 coupled to communication infrastructure 2102 via a storage interface 2138. Storage device 2140 generally represents any type or form of storage device or medium capable of storing data and/or other computer-readable instructions. For example, storage device 2140 is a magnetic disk drive, a solid-state drive, an optical disk drive, a flash drive, or the like. Storage interface 2138 generally represents any type or form of interface or device for transferring data between storage device 2140 and other components of content player 1920.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

### First Set of Example Embodiments

Example 1: A computer-implemented method comprising: identifying, within a media item, one or more phonemes and one or more visemes that correspond to the phonemes, accessing one or more portions of contextual data related to the identified phonemes and corresponding visemes, identifying one or more specified moments in the media item in which alignment between the phonemes and visemes has an importance level that is above a minimum threshold value based on the contextual data, and providing, to one or more entities, an indication of the identified moments in which alignment between the visemes and phonemes has an importance level that is above the minimum threshold value.

Example 2. The computer-implemented method of Example 1, wherein the indication of the identified moments in which alignment between the visemes and phonemes has the increased level of importance is provided to a dub creator for implementation in creating a dub for the media item.

Example 3. The computer-implemented method of Example 1 or Example 2, wherein the identified moments in the media item are flagged to receive additional scrutiny during creation of the dub for the media item beyond a baseline level of scrutiny.

Example 4. The computer-implemented method of any of Examples 1-3, wherein the contextual data related to the identified phonemes and visemes comprises an indication of video shot type for the identified moment.

Example 5. The computer-implemented method of any of Examples 1-4, wherein the contextual data related to the identified phonemes and visemes comprises an indication of an amount of lighting in the identified moment.

Example 6. The computer-implemented method of any of Examples 1-5, wherein the contextual data related to the identified phonemes and visemes comprises an indication of how clearly a character's mouth is visible in the identified moment.

Example 7. The computer-implemented method of any of Examples 1-6, wherein the contextual data related to the identified phonemes and visemes comprises at least one of an indication of a character's face size, a frequency of the character's lips flapping, an identity of the character, a genre of the media item, or a context associated with the identified moment.

Example 8. The computer-implemented method of any of Examples 1-7, wherein the contextual data related to the identified phonemes and visemes comprises an indication of a video shot, a video scene, or a dialogue occurring during the identified moment.

Example 9. The computer-implemented method of any of Examples 1-8, wherein the contextual data related to the identified phonemes and visemes comprises an indication of a character's actions during the identified moment.

Example 10. The computer-implemented method of any of Examples 1-9, further comprising generating a dub for the media item, wherein the identified moments in the media item receive additional scrutiny during creation of the dub beyond a baseline level of scrutiny.

Example 11. The computer-implemented method of any of Examples 1-10, wherein identifying, within the media item, the one or more phonemes and the one or more visemes that correspond to the phonemes comprises determining when an entity's lips flap and when audio sounds corresponding to the lip flaps occur.

Example 12. The computer-implemented method of any of Examples 1-11, further comprising training a machine learning model to identify the one or more specified moments in the media item based on one or more portions of historical data related to other media items.

Example 13. The computer implemented method of any of claims 1-12, wherein the machine learning model is a multimodal model that analyzes at least audio information and video information related to the media item.

Example 14. A system comprising at least one physical processor and physical memory comprising computer-executable instructions that, when executed by the physical processor, cause the physical processor to: identify, within a media item, one or more phonemes and one or more visemes that correspond to the phonemes, access one or more portions of contextual data related to the identified phonemes and corresponding visemes, identify one or more specified moments in the media item in which alignment between the phonemes and visemes has an importance level that is above a minimum threshold value based on the contextual data, and provide, to one or more entities, an indication of the identified moments in which alignment between the visemes and phonemes has an importance level that is above the minimum threshold value.

Example 15. The system of Example 14, wherein the computer-executable instructions further cause the processor to generate a dub for the media item, wherein additional scrutiny is given to the one or more specified moments in the media item when creating the dub beyond a baseline level of scrutiny.

Example 16. The system of Example 14 or Example 15, wherein the computer-executable instructions further cause the processor to generate a dubbing evaluation result that indicates how well one or more dubbed phonemes match the corresponding visemes of the media item.

Example 17. The system of any of Examples 14-16, wherein the computer-executable instructions further cause the processor to initiate a redub of the media item upon determining that the dubbing evaluation result for the media item is below an established threshold value.

Example 18. The system of any of Examples 14-17, wherein generating the dubbing evaluation result and initiating the redub of the media item forms a feedback loop that provides higher quality dubs.

Example 19. The system of any of Examples 14-18, wherein the media item comprises at least one of an animated film or a video game.

Example 20. A non-transitory computer-readable medium comprising one or more computer-executable instructions that, when executed by at least one processor of a computing device, cause the computing device to: identify, within a media item, one or more phonemes and one or more visemes that correspond to the phonemes, access one or more portions of contextual data related to the identified phonemes and corresponding visemes, identify one or more specified moments in the media item in which alignment between the phonemes and visemes has an importance level that is above a minimum threshold value based on the contextual data, and provide, to one or more entities, an indication of the identified moments in which alignment between the visemes and phonemes has an importance level that is above the minimum threshold value.

### Second Set of Example Embodiments

Example 1: A computer-implemented method comprising: accessing a media item that has been dubbed into a secondary language, the media item including one or more phonemes and one or more corresponding visemes associated with at least one moment when an entity is speaking, analyzing the media item to identify lip shape and/or lip flap timing for the entity during the at least one moment in the media item in which the entity is speaking, for the at least one moment in the media item, comparing the identified lip shape and/or the identified lip flap timing to the accessed phonemes and/or visemes, and generating a dubbing evaluation result for the media item based on the comparison between lip shape and/or lip flap timing to the accessed phonemes and/or visemes for the at least one moment in the media item.

Example 2. The computer-implemented method of Example 1, further comprising identifying, for the at least one moment and for a plurality of additional moments, which entity is actively speaking, and training a machine learning model to map the visemes to one or more of the phonemes for the actively speaking entity.

Example 3. The computer-implemented method of Example 1 or Example 2, wherein the machine learning model is trained to map visemes to phonemes on a plurality of different media items.

Example 4. The computer-implemented method of any of Examples 1-3, wherein the machine learning model is trained to identify the actively speaking entity's lip shape for each frame of the specified moment.

Example 5. The computer-implemented method of any of Examples 1-4, wherein the machine learning model is trained to predict an implied lip shape based on a specified phoneme.

Example 6. The computer-implemented method of any of Examples 1-5, wherein the machine learning model implements data from encoders that are configured to identify both lip shape and lip flap timing.

Example 7. The computer-implemented method of any of Examples 1-6, wherein the machine learning model is configured to determine an amount of cross-attention between an encoded audio stream and an encoded video stream from the media item.

Example 8. The computer-implemented method of any of Examples 1-7, wherein the machine learning model ingests, as a ground truth, an initial audio and video stream that corresponds to the media item in its original, non-dubbed form.

Example 9. The computer-implemented method of any of Examples 1-8, wherein the machine learning model compares the ground truth audio and video stream to the phonemes and visemes of the media item that has been dubbed into the secondary language to generate the dubbing evaluation result.

Example 10. The computer-implemented method of any of Examples 1-9, wherein the comparison between the ground truth audio and video stream and the phonemes and visemes of the media item provides feedback indicating one or more changes that would improve the machine learning model.

Example 11. The computer-implemented method of any of Examples 1-10, further comprising calibrating the machine learning model using the provided feedback.

Example 12. The computer-implemented method of any of Examples 1-11, further comprising providing the generated dubbing evaluation result to a dub generating entity.

Example 13. A system comprising at least one physical processor and physical memory comprising computer-executable instructions that, when executed by the physical processor, cause the physical processor to: access a media item that has been dubbed into a secondary language, the media item including one or more phonemes and one or more corresponding visemes associated with at least one moment when an entity is speaking, analyze the media item to identify lip shape and/or lip flap timing for the entity during the at least one moment in the media item in which the entity is speaking, for the at least one moment in the media item, compare the identified lip shape and/or the identified lip flap timing to the accessed phonemes and/or visemes, and generate a dubbing evaluation result for the media item based on the comparison between lip shape and/or lip flap timing to the accessed phonemes and/or visemes for the at least one moment in the media item.

Example 14. The system of Example 13, wherein the dubbing evaluation result is inferred implicitly based on one or more behavioral signals, without specific indications of approval or disapproval.

Example 15. The system of Example 13 or Example 14, wherein the generated dubbing evaluation result for the media item is used to predict an amount by which a viewer is more likely to consume at least a minimum amount of the media item because of the dubbing evaluation result.

Example 16. The system of any of Examples 13-15, wherein the computer-executable instructions further cause the processor to initiate a redub of the media item upon determining that the dubbing evaluation result for the media item is below an established threshold value.

Example 17. The system of any of Examples 13-16, wherein generating the dubbing evaluation result and initiating the redub of the media item forms a feedback loop that provides higher quality dubs.

Example 18. The system of any of Examples 13-17, wherein the computer-executable instructions further cause the processor to train a machine learning model to identify one or more specified moments in the media item in which alignment between the phonemes and visemes has an importance level that is above a minimum threshold value based on one or more portions of historical data related to other media items.

Example 19. The system of any of Examples 13-18, wherein the machine learning model is a multimodal model that analyzes at least audio information and video information related to the media item.

Example 20. A non-transitory computer-readable medium comprising one or more computer-executable instructions that, when executed by at least one processor of a computing device, cause the computing device to: access a media item that has been dubbed into a secondary language, the media item including one or more phonemes and one or more corresponding visemes associated with at least one moment when an entity is speaking, analyze the media item to identify lip shape and/or lip flap timing for the entity during the at least one moment in the media item in which the entity is speaking, for the at least one moment in the media item, compare the identified lip shape and/or the identified lip flap timing to the accessed phonemes and/or visemes, and generate a dubbing evaluation result for the media item based on the comparison between lip shape and/or lip flap timing to the accessed phonemes and/or visemes for the at least one moment in the media item.

### Third Set of Example Embodiments

Example 1: A computer-implemented method comprising: accessing a data set that includes a plurality of different types of data for a specified media item, instantiating a probative test to determine, based on the different types of data, which media item characteristics affect how the media item is received by users that have played back the media item, as part of the probative test, isolating a plurality of media item characteristics that affect how the media item is received by users, wherein lip sync quality is omitted from the plurality of isolated media item characteristics, and training a machine learning model, using the isolated media item characteristics, to predict an amount by which user retention will be affected based on a specified amount of change in lip sync quality.

Example 2. The computer-implemented method of Example 1, wherein the amount by which user retention will be affected based on the specified amount of change in lip sync quality comprises a success metric associated with the media item.

Example 3. The computer-implemented method of Example 1 or Example 2, further comprising implementing the trained machine learning model to predict the amount by which user retention will be affected based on the specified amount of change in lip sync quality.

Example 4. The computer-implemented method of any of Examples 1-3, further comprising establishing a feedback loop for the trained machine learning model, wherein the feedback loop receives, as inputs, new media items with corresponding lip sync quality indicators.

Example 5. The computer-implemented method of any of Examples 1-4, wherein lip sync quality includes a dub quality for a corresponding dub into a secondary language.

Example 6. The computer-implemented method of any of Examples 1-5, wherein the probative test compares user retention of the media item in its original language to user retention of the media item in the dubbed, secondary language.

Example 7. The computer-implemented method of any of Examples 1-6, further comprising identifying a gap size between the user retention of the media item in its original language and the user retention of the media item in the dubbed, secondary language.

Example 8. The computer-implemented method of any of Examples 1-7, wherein the probative test additionally compares user retention of the media item in its original language to user retention of the media item in a dubbed, tertiary language and identifies a gap size between the user retention of the media item in its original language and the user retention of the media item in the dubbed, secondary language and in the dubbed, tertiary language.

Example 9. The computer-implemented method of any of Examples 1-8, wherein the machine learning model is trained to predict the amount by which user retention will be affected based on the specified amount of change in lip sync quality for a plurality of different media items consumed by a specific user.

Example 10. The computer-implemented method of any of Examples 1-9, wherein the machine learning model is trained to predict the amount by which user retention will be affected based on the specified amount of change in lip sync quality for a plurality of different users that have consumed the specified media item.

Example 11. The computer-implemented method of any of Examples 1-10, wherein at least two of the plurality of different users reside in different countries.

Example 12. The computer-implemented method of any of Examples 1-11, wherein the isolated media item characteristics that affect how the media item is received by users include at least one cultural affinity, user taste, media item performance, location, genre, or user behavior.

Example 13. A system comprising at least one physical processor and physical memory comprising computer-executable instructions that, when executed by the physical processor, cause the physical processor to: access a data set that includes a plurality of different types of data for a specified media item, instantiate a probative test to determine, based on the different types of data, which media item characteristics affect how the media item is received by users that have played back the media item, as part of the probative test, isolate a plurality of media item characteristics that affect how the media item is received by users, wherein lip sync quality is omitted from the plurality of isolated media item characteristics, and train a machine learning model, using the isolated media item characteristics, to predict an amount by which user retention will be affected based on a specified amount of change in lip sync quality.

Example 14. The system of Example 13, wherein the computer-executable instructions further cause the processor to validate the predicted amount by which user retention will be affected based on the specified amount of change in lip sync quality.

Example 15. The system of Example 13 or Example 14, wherein the validating includes performing one or more A/B tests with different levels of lip sync quality.

Example 16. The system of any of Examples 13-15, wherein the validating further includes analyzing results of the A/B tests and calibrating the trained machine learning model using the results of the A/B tests.

Example 17. The system of any of Examples 13-16, wherein the machine learning model predicts the amount by which user retention will be affected based on the specified amount of change in lip sync quality for one or more specified moments in the media item that received additional scrutiny beyond a baseline level of scrutiny.

Example 18. The system of any of Examples 13-17, wherein media items corresponding to at least one specific genre receive additional scrutiny beyond the baseline level of scrutiny.

Example 19. The system of any of Examples 13-18, wherein the computer-executable instructions further cause the processor to implement the trained machine learning model to predict the amount by which user retention will be affected based on the specified amount of change in lip sync quality.

Example 20. A non-transitory computer-readable medium comprising one or more computer-executable instructions that, when executed by at least one processor of a computing device, cause the computing device to: access a data set that includes a plurality of different types of data for a specified media item, instantiate a probative test to determine, based on the different types of data, which media item characteristics affect how the media item is received by users that have played back the media item, as part of the probative test, isolate a plurality of media item characteristics that affect how the media item is received by users, wherein lip sync quality is omitted from the plurality of isolated media item characteristics, and train a machine learning model, using the isolated media item characteristics, to predict an amount by which user retention will be affected based on a specified amount of change in lip sync quality.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying, within a media item, one or more phonemes and one or more visemes that correspond to the phonemes;
accessing one or more portions of contextual data related to the identified phonemes and corresponding visemes;
identifying one or more specified moments in the media item in which alignment between the phonemes and visemes has an importance level that is above a minimum threshold value based on the contextual data; and
providing, to one or more entities, an indication of the identified moments in which alignment between the visemes and phonemes has an importance level that is above the minimum threshold value.

2. The computer-implemented method of claim 1, wherein the indication of the identified moments in which alignment between the visemes and phonemes has an increased level of importance is provided to a dub creator for implementation in creating a dub for the media item.

3. The computer-implemented method of claim 2, wherein the identified moments in the media item are flagged to receive additional scrutiny during creation of the dub for the media item beyond a baseline level of scrutiny.

4. The computer-implemented method of claim 1, wherein the contextual data related to the identified phonemes and visemes comprises an indication of video shot type for the identified moment.

5. The computer-implemented method of claim 1, wherein the contextual data related to the identified phonemes and visemes comprises an indication of an amount of lighting in the identified moment.

6. The computer-implemented method of claim 1, wherein the contextual data related to the identified phonemes and visemes comprises an indication of how clearly a character's mouth is visible in the identified moment.

7. The computer-implemented method of claim 1, wherein the contextual data related to the identified phonemes and visemes comprises at least one of an indication of a character's face size, a frequency of the character's lips flapping, an identity of the character, a genre of the media item, or a context associated with the identified moment.

8. The computer-implemented method of claim 1, wherein the contextual data related to the identified phonemes and visemes comprises an indication of a video shot, a video scene, or a dialogue occurring during the identified moment.

9. The computer-implemented method of claim 1, wherein the contextual data related to the identified phonemes and visemes comprises an indication of a character's actions during the identified moment.

10. The computer-implemented method of claim 1, further comprising generating a dub for the media item, wherein the identified moments in the media item receive additional scrutiny during creation of the dub beyond a baseline level of scrutiny.

11. The computer-implemented method of claim 1, wherein identifying, within the media item, the one or more phonemes and the one or more visemes that correspond to the phonemes comprises determining when an entity's lips flap and when audio sounds corresponding to the lip flaps occur.

12. The computer-implemented method of claim 1, further comprising training a machine learning model to identify the one or more specified moments in the media item based on one or more portions of historical data related to other media items.

13. The computer-implemented method of claim 12, wherein the machine learning model is a multimodal model that analyzes at least audio information and video information related to the media item.

14. A system comprising:
at least one physical processor; and
physical memory comprising computer-executable instructions that, when executed by the physical processor, cause the physical processor to:
identify, within a media item, one or more phonemes and one or more visemes that correspond to the phonemes;
access one or more portions of contextual data related to the identified phonemes and corresponding visemes;
identify one or more specified moments in the media item in which alignment between the phonemes and visemes has an importance level that is above a minimum threshold value based on the contextual data; and
provide, to one or more entities, an indication of the identified moments in which alignment between the visemes and phonemes has an importance level that is above the minimum threshold value.

15. The system of claim 14, wherein the computer-executable instructions further cause the processor to generate a dub for the media item, wherein additional scrutiny is given to the one or more specified moments in the media item when creating the dub beyond a baseline level of scrutiny.

16. The system of claim 15, wherein the computer-executable instructions further cause the processor to generate a dubbing evaluation result that indicates how well one or more dubbed phonemes match the corresponding visemes of the media item.

17. The system of claim 16, wherein the computer-executable instructions further cause the processor to initiate a redub of the media item upon determining that the dubbing evaluation result for the media item is below an established threshold value.

18. The system of claim 17, wherein generating the dubbing evaluation result and initiating the redub of the media item forms a feedback loop that provides higher quality dubs.

19. The system of claim 14, wherein the media item comprises at least one of an animated film or a video game.

20. A non-transitory computer-readable medium comprising one or more computer-executable instructions that, when executed by at least one processor of a computing device, cause the computing device to:
identify, within a media item, one or more phonemes and one or more visemes that correspond to the phonemes;
access one or more portions of contextual data related to the identified phonemes and corresponding visemes;
identify one or more specified moments in the media item in which alignment between the phonemes and visemes has an importance level that is above a minimum threshold value based on the contextual data; and
provide, to one or more entities, an indication of the identified moments in which alignment between the visemes and phonemes has an importance level that is above the minimum threshold value.
